(19) United States
(12) Patent Application Publication
(10) Pub. No.: US 2012/0240111 A1
(43) Pub. Date: Sep. 20, 2012

(54) STORAGE MEDIUM STORING PROGRAM FOR CONTROLLING VIRTUAL MACHINE, COMPUTING MACHINE, AND METHOD FOR CONTROLLING VIRTUAL MACHINE

(75) Inventor: Takashi KOBAYASHI, Kawasaki (JP)

(73) Assignee: FUJITSU LIMITED, Kawasaki-shi (JP)

(21) Appl. No.: 13/316,141

(22) Filed: Dec. 9, 2011

(30) Foreign Application Priority Data
Mar. 18, 2011 (JP) 2011-061671

(51) Int. Cl. G06F 9/455

(52) U.S. Cl. 718/1

(57) ABSTRACT

A computer executes processes of: setting the upper limit of an available processing capacity for each user; setting a plurality of virtual machines for each of the users; and distributing the processing capacity to the plurality of virtual machines for each of the users within the upper limit of the processing capacity set for each of the users.

### CROSS-REFERENCE TO RELATED APPLICATION

This application is based upon and claims the benefit of priority of the prior Japanese Patent Application No. 2011-061671, filed on Mar. 18, 2011, the entire contents of which are incorporated herein by reference.

### FIELD

The Specification relates to a virtual machine.

### BACKGROUND

In recent years, a virtualization technology has been widespread for operating a plurality of virtual machines (VMs) simultaneously on one server. Using the virtualization technology, each VM can run an operating system (OS). As a result, a plurality of OSs can be run in parallel on one server, and hence the server resource can be utilized effectively.

As an example, in regard to a virtual machine system, there is a technology in which the power consumption is decreased via the entirety of the system optimizing a physical CPU (Central Processing Unit) to which a virtual CPU is not allocated. The virtual machine system includes a virtualization control unit. The virtualization control unit divides a physical machine including a plurality of physical CPUs into a plurality of logical blocks, wherein the plurality of physical CPUs is capable of switching the state between a sleep state and a normal operation state. The virtualization control unit also operates a guest OS on each of the logical blocks, and controls the allocation of the resources of the physical machine to each logical block. The virtualization control unit performs the following processes. The virtualization control unit receives an operation command to the logical blocks. When the received operation command is an operation command to delete a virtual CPU from a logical block control unit, the virtualization control unit deletes the virtual CPU from a table which manages virtual CPUs, the allocation state of the physical CPUs, and the operation state of the physical CPUs. When a virtual CPU allocated to a physical CPU from which a virtual CPU has been deleted runs short, the virtualization control unit puts this physical CPU into the sleep state.

### SUMMARY

A virtual-machine control program which controls a plurality of virtual machines causes a computer to execute the following processes. The computer sets the upper limit of an available processing capacity for each user. The computer sets a plurality of virtual machines for each of the users. The computer distributes the processing capacity to the plurality of virtual machines set for each of the users within the upper limit of the processing capacity set for each of the users.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a configuration of a real machine which runs a plurality of virtual machines in accordance with the first embodiment.

FIG. 2 illustrates an example of a functional block diagram of a VMM in accordance with the first embodiment.

FIG. 3 illustrates a diagram illustrating a FIX (upper limit) setting and an AUTO (FREE) setting of a VM or sub VM in accordance with the first embodiment.

FIG. 4 illustrates an example of a configuration block diagram of hardware 2 of a computing machine 1 in accordance with the first embodiment.

FIG. 5 illustrates an example of a functional block diagram of the computing machine 1 in accordance with the first embodiment.

FIG. 6 illustrates an example of processing details of a work space setting unit 31 in accordance with the first embodiment.

FIG. 7 illustrates an example of processing details of a distribution processing unit 32 in accordance with the first embodiment.

FIG. 8 illustrates an example of processing details of an instruction time obtainment unit 33 in accordance with the first embodiment.

FIGS. 9A and 9B each illustrate an example of VM control information stored by a control information storage unit 36 in accordance with the first embodiment.

FIGS. 10A, 10B and 10C are each diagrams illustrating information expanded in an allocation work space in accordance with the first embodiment.

FIG. 11 illustrates an example of a flowchart which indicates a procedure for distributing processes, the procedure being executed by the control unit 12 in accordance with the first embodiment.

FIGS. 12A, 12B and 12C are each a diagram illustrating a sequential distribution process (fix) in accordance with the first embodiment.

FIG. 13 illustrates a result of the sequential distribution process (fix) illustrated in FIG. 12.

FIGS. 14A, 14B and 14C are each a diagram illustrating a sequential distribution process (an average distribution mode) in accordance with the first embodiment.

FIG. 15 illustrates a result of the sequential distribution process (an average distribution mode) illustrated in FIG. 14.

FIG. 16 illustrates an example of the flow of the sequential distribution process in accordance with the first embodiment.

FIGS. 17A and 17B each illustrate an example of the flow of a consecutive distribution process in accordance with the first embodiment.

FIG. 18 is a diagram illustrating a capacity lower limit value application process in accordance with the first embodiment.

FIG. 19 illustrates an example of the detailed flow of the capacity lower limit value application process (S42) in accordance with the first embodiment.

FIG. 20 illustrates an example of a configuration block diagram of hardware 2 of a computing machine 1 in accordance with the second embodiment.

FIG. 21 illustrates an example of a functional block of the computing machine 1 in accordance with the second embodiment.

FIG. 22 illustrates a flowchart which indicates a procedure for distributing processes, the procedure being executed by a control unit 12a in accordance with the second embodiment.

FIG. 23 illustrates an example of details of the process of S81.

### DESCRIPTION OF EMBODIMENTS

The following method is an example of a method for operating a VM. For example, one real machine utilized by one user is divided into a VM for a production system (i.e., a production system VM) and a VM for a development system (i.e., a development system VM). An upper limit is then set for the processing capacity of the CPU which can be used for the development system, but an upper limit is not set for the processing capacity of the CPU which can be used for the production system (the AUTO setting or the FREE setting). As described above, the AUTO setting (the FREE setting) is not applied to the VM for the development system, and the reason for this is as follows.

When, for example, processes of the development system VM are looped due to a bug in a program under development and when the AUTO setting (the FREE setting) is applied to the processing capacity of the development system VM, then even the processing capacity of the CPU of the production system may be used so that the processes of the production system cannot be performed.

Accordingly, the upper limit of the processing capacity of the CPU is determined in the development system. In many cases, the system runs all day in the production system, i.e., the system runs online during the day and via patch processing at night.

In regard to the development system, by contrast, development operations are often performed during standard working hours. Accordingly, if the AUTO setting (the FREE setting) is applied to the production system, the CPU capacity allocated to the development system can be used for the production system during a time zone such as midnight during which the CPU capacity is not used by the development system. As a result, the system can be used efficiently.

In an outsourcing service such as a cloud system, one real machine may be divided into a plurality of VMs so that a plurality of users can use them. Each user may have two or more kinds of VMs, including the production system (this may also be divided into a basic system, information system, and the like in accordance with operations) and the development system.

In this case, the operation technique described above could cause the following event. For example, assume that the AUTO setting (the FREE setting) is applied to the CPU capacity of the production system of a user A and an upper limit is set to the CPU capacity of the development system of the user A. In this case, the AUTO setting (the FREE setting) is applied to the CPU capacity of the production system of the user A. Accordingly, if, for example, there is a surplus portion of the processing capacity of the CPU of the development system of the user A as well as a surplus portion of the processing capacity of the CPU of the development system or production system of a user B, even the processing capacity of the CPU allocated to the user B could be used. As a result, the user A can use an amount of allocation which is larger than the total amount of CPU allocation which conforms to the outsourcing service contract.

Meanwhile, while an allocation surplus portion of the development system of the user B is being used for the production system of the user A, the production system of the user B cannot use the allocation surplus portion of the development system of the user B which is supposed to be used by it. As a result, the user B can only use an amount of allocation which is smaller than the total amount of CPU allocation which conforms to the contract.

Accordingly, in accordance with the present embodiment, descriptions will be given of a virtual machine technology which is capable of effectively utilizing the resources of a plurality of virtual machines of users within the scope of the processing capacities distributed to the users. Here, as an example, descriptions will be given of a virtual machine wherein at least one real machine is shared by a plurality of users by running a plurality of VMs. That is, even when each user uses a VM to which a FREE setting has been applied with respect to a processing capacity of the CPU and a VM for which an upper limit has been set with respect to the processing capacity of the CPU, the virtual machine may control the CPU processing capacity within the scope of the processing capacity of a CPU allocated to each user.

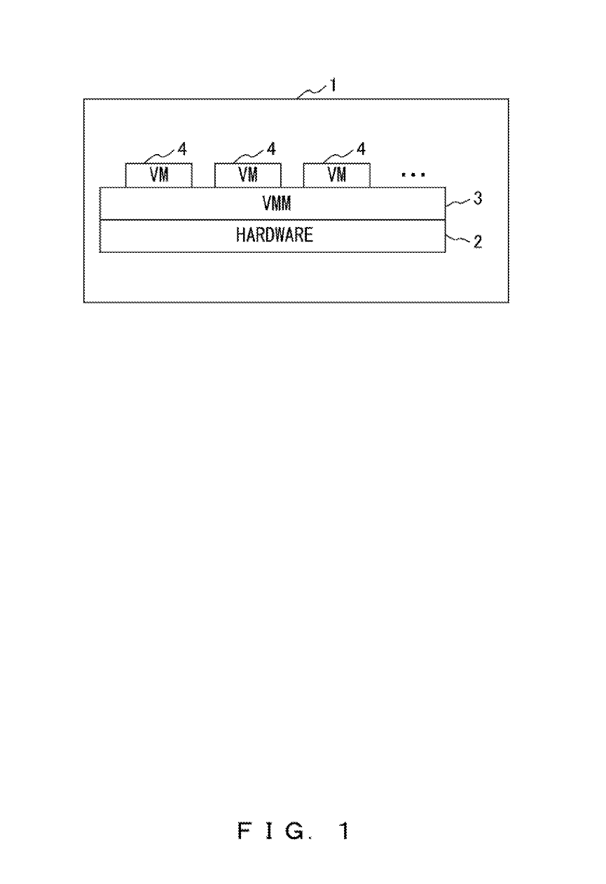

FIG. 1 illustrates an example of a configuration of a real machine which runs a plurality of virtual machines in accordance with a first embodiment. The computing machine 1 functions as a plurality of virtual machines (VMs) by executing a virtual machine monitor (VMM) as a virtualization program.

The computing machine 1 includes the hardware 2, a virtual machine monitor (VMM) 3, and a plurality of virtual machines (VMs) 4. The hardware 2 is a physical device group which includes a real CPU, a real storage apparatus, and the like. The hardware 2 will be described hereafter.

The VMM 3 is a program which provides the plurality of VMs (4) with a virtual hardware environment to run and control the VMs (4) on the computing machine 1. In particular, the VMM 3 dispatches an operating system (OS) of each of the VMs 4 (i.e., allocates the ownership of the physical CPU), emulates privileged instructions executed by the OSs, and controls the hardware 2 such as a physical CPU.

The VMs (4) are each a virtual machine which operates on the VMM 3 independently from the other VMs (4). Each of the VMs (4) is realized when its OS obtains the ownership of a physical CPU of the hardware 2 via the VMM 3 and is then executed on the physical CPU.

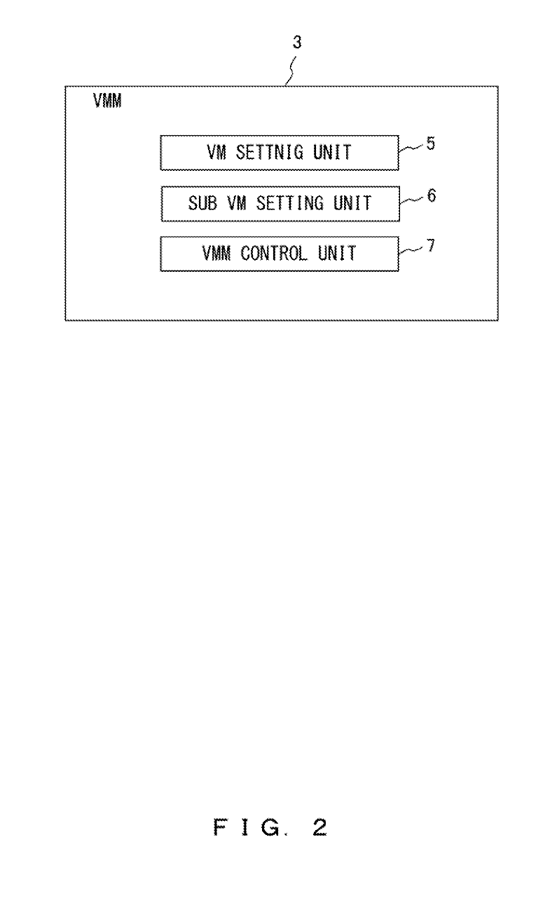

FIG. 2 illustrates an example of a functional block diagram of a VMM in accordance with the first embodiment. The VMM 3 includes a VM setting unit 5, a sub VM setting unit 6, and a VMM control unit 7.

The VM setting unit 5 sets the upper limit of an available processing capacity for each user. The VM setting unit 5 sets at least one virtual machine as an upper virtual machine for each of the users within the upper limit of the available processing capacity set for each of them. That is, the VM setting unit 5 obtains information for using the VM for each user on the VMM 3 through an input apparatus or network and adjusts setting of the VM. The information for using the VM is, for example, information relating to the upper limit or lower limit of the distribution of the processing capacity of the CPU or information relating to cancellation information and the like for cancelling such limitations. The VM setting unit 5 is an example of a first setting unit.

The sub VM setting unit 6 sets a plurality of virtual machines for each user. The sub VM setting unit 6 sets the plurality of virtual machines as lower virtual machines under the control of the upper virtual machine which has been set. That is, the sub VM setting unit 6 obtains information for using VMs (i.e., sub VMs) generated by dividing a VM through an input apparatus or network and adjusts setting of the sub VMs. The information for using the sub VMs is, for example, information relating to the upper limit or lower limit of the distribution of the processing capacity of the CPU or information relating to cancellation information and the like for cancelling such limitations. The sub VM setting unit 6 is an example of a second setting unit.

The VMM control unit 7 distributes the processing capacity to the plurality of virtual machines for each user within the upper limit of the processing capacity set for each user. The VMM control unit 7 generates and controls a VM and/or sub VM in accordance with a content set by the VM unit 5 and/or sub VM setting unit. As an example, within the range of the distribution value of a CPU processing capacity set for each VM, the VMM control unit 7 distributes the CPU processing capacity to each sub VM within the VM in accordance with the distribution value of the CPU processing capacity allocated to each sub VM. The VMM control unit 7 is an example of a distribution processing unit.

As a result, the resource of a plurality of virtual machines for each user can be effectively utilized within the scope of the processing capacity distributed to each user.

The sub VM setting unit 6 sets the upper limit of a processing capacity of each virtual machine controlled by the upper virtual machine within the scope of the processing capacity distributed to the upper virtual machine. When any of the lower virtual machines controlled by the upper virtual machine has applied to it a limitation cancellation setting for cancelling the upper limit of the processing capacity distributed to the lower virtual machines, then the VMM control unit 7 performs the following processes. The VMM control unit 7 distributes, to a lower virtual machine which has applied to it the limitation cancellation setting, a processing capacity which has been distributed to an unused lower virtual machine for which the upper limit of the processing capacity has been set under the control of the same upper virtual machine.

As a result, even when the FREE setting is applied with respect to the distribution of the processing capacity of the CPU of a sub VM, the processing capacity of the CPU distributed to each user cannot be used beyond the processing capacity of the CPU.

The sub VM setting unit 6 sets the lower limit of the processing capacity of any of the lower virtual machines. The VMM control unit 7 ensures that the processing capacity is distributed to the lower virtual computer for which a lower limit has been set. In this case, the VMM control unit 7 distributes, to a lower virtual machine which has applied to it the limitation cancellation setting, a processing capacity exceeding the ensured processing capacity from among the processing capacity which has been distributed to an unused lower virtual machine for which the upper limit of the processing capacity has been set under the control of the same upper virtual machine.

As a result, even when the sub VM for which a lower limit of processing capacity has been set is not being used, the processing capacity distributed to this sub VM is ensured and thus can be used any time desired.

The VMM control unit 7 includes the first control unit and the second control unit. The first control unit distributes processing capacity to a plurality of upper virtual machines. The second control unit distributes processing capacity to a plurality of virtual machines controlled by an upper virtual machine. The first CPU 12a-1 is an example of the first control unit. The second CPU 12a-2 is an example of the second control unit.

As a result, since processes can be prevented from concentrating on the first control unit, processing loads on the first control unit may be reduced. In addition, since a plurality of CPUs can deal with the process performed on a sub-VM by sub-VM basis, the processing speed may be enhanced.

The VMM control unit 7 may allocate a processing execution time to an upper virtual machine or lower virtual machine in an order which depends on the processing capacity distributed to the upper virtual machine or the lower virtual machine.

As a result, instruction processing may be distributed to each VM or each sub VM in accordance with the CPU distribution value.

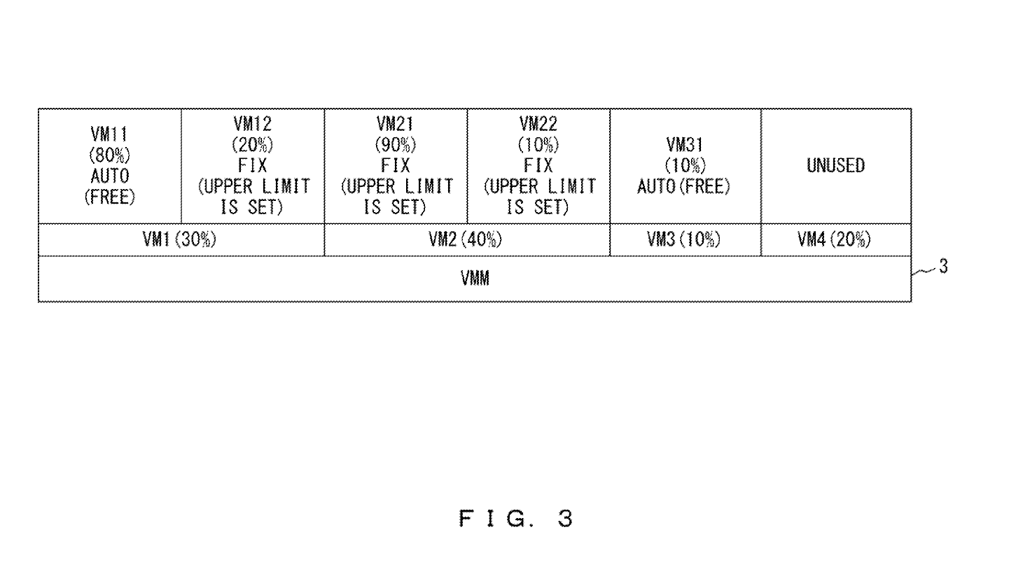

As described above, the information for using a VM includes information indicating whether to use the CPU processing capacity within the upper limit or lower limit of the distribution of the processing capacity of the CPU or information relating to cancellation information and the like for cancelling such limitations. In the present embodiment, such information is referred to as a “system use mode”. The system use mode includes a setting for fixedly holding the distribution value of the processing capacity of a CPU (the FIX setting) or a setting for dynamically changing the distribution value of the processing capacity of a CPU (the AUTO setting (or the FREE setting)). This will be described with reference to FIG. 3.

FIG. 3 illustrates a diagram illustrating FIX (upper limit) setting and AUTO (FREE) setting of a VM or sub VM in accordance with the first embodiment. The VMM control unit 7 fixedly provides each VM with the upper limit of the CPU processing capacity in accordance with the distribution value set for each VM. In the example in FIG. 3, the VMM 3 distributes 30%, 40%, 10% and 20% of the CPU processing capacity to VM 1, VM 2, VM 3 and VM 4, respectively.

The VMM 3 causes the VMs to work in cooperation with each other. Each of the VMs performs a control within the scope of the CPU processing capacity provided by the VMM. When sub VMs are in the VM, they perform a control within the scope of the CPU processing capacity provided by the VMM. The operation of the sub VMs is similar to the operation of the VM without sub VMs.

In the example in FIG. 3, the VMM 3 distributes 80% and 20% of the CPU processing capacity of the VM 1 to VM 11 and VM 12 of VM 1, respectively. The VMM 3 also distributes 90% and 10% of the CPU processing capacity of the VM 2 to VM 21 and VM 22 of VM 2, respectively. The VMM 3 also distributes 10% of the CPU processing capacity of the VM 3 to VM31 of VM 3. The VM 4 is unused.

The system usage settings of the VM 11 and the VM12 of the VM 1 have been set to AUTO and FIX, respectively. In this case, when the AUTO setting is validated, then, within the CPU processing capacity of the VM 1, the sub VM 11 to which the AUTO setting has been applied may use the CPU processing capacity distributed to a sub VM which is not currently used and to which the FIX setting has been applied. In FIG. 3, while the sub VM 12 is not being used, the sub VM 11 may use the CPU processing capacity distributed to itself (80%) as well as the CPU processing capacity distributed to the sub VM 12 (20%).

The VM 12 to which the FIX setting has been applied may use the CPU processing capacity within the scope of the CPU processing capacity distributed to itself (20%). However, when the CPU processing capacity distributed to the VM 12 is already being used by the VM 11 in which the AUTO setting has been validated, the VM 12 cannot use its CPU processing capacity until processes performed by the VM 11 are finished.

In regard to the VM 2, the VM 21 and the VM 22 to which the FIX setting has been applied may respectively use the CPU processing capacity within 90% and 10% of the CPU processing capacity of the VM 2 distributed to them.

In regard to VM 3, assume that the system usage setting of the VM 31 has been set to the AUTO setting and that the FIX setting has been applied to the upper VM 3. In this case, despite the fact that the AUTO setting has been applied to the VM 31, up to 10% of the CPU processing capacity of VM 31 may be used. When this function is used, the upper VM is in, for example, FIX mode.

The VM 4 is not being used. In this case, the VMM 3 performs a wait state control on the VM 4 such that the other VMs in operation cannot use the CPU processing capacity distributed to the VM 4.

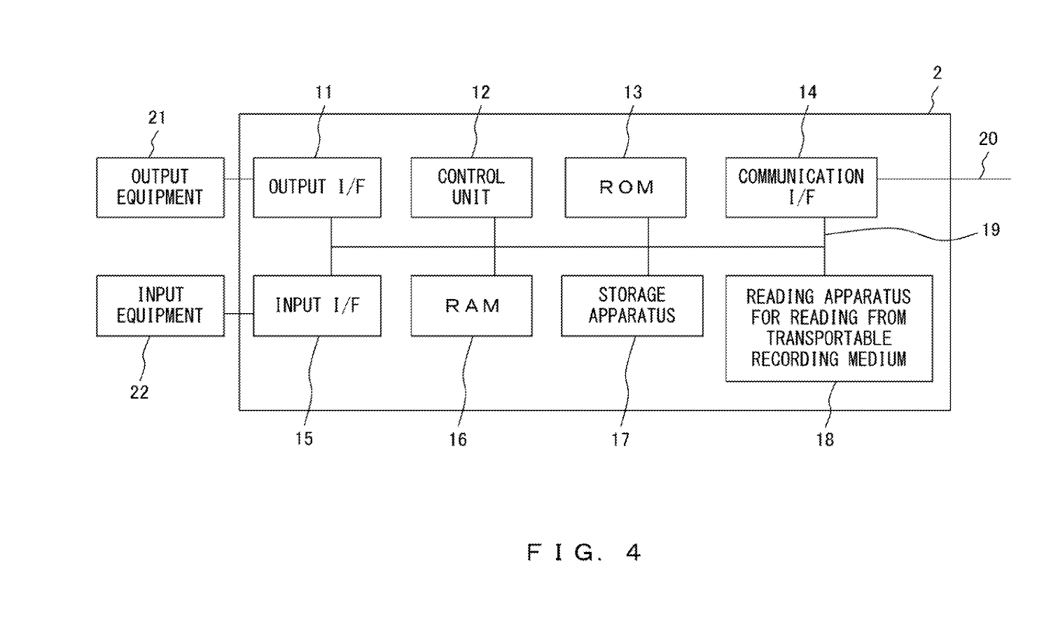

FIG. 4 illustrates an example of a configuration block diagram of the hardware 2 of the computing machine 1 in accordance with the first embodiment. The computing machine 1 includes a control unit 12, a ROM 13, a RAM 16, a communication I/F 14, a storage apparatus 17, an output I/F 11, an input I/F 15, a reading apparatus 18, a bus 19, output equipment 21, and input equipment 22. Here, CPU indicates a central processing unit. ROM indicates a read-only memory. RAM indicates a random access memory. I/F indicates an interface.

The bus 19 is connected to the control unit 12, the ROM 13, the RAM 16, the communication I/F 14, the storage apparatus 17, the output I/F 11, the input I/F 15, the reading apparatus 18, and the like. The reading apparatus 18 reads data from a transportable recording medium. The output equipment 21 is connected to the output I/F 11. The input equipment 22 is connected to the input I/F 15.

Various storage apparatuses, such as a hard disk drive, a flash memory apparatus, and a magnetic disk apparatus, may be used as the storage apparatus 17. The RAM 16 is used as, for example, a work space for temporarily storing data.

The storage apparatus 17 or the ROM 13 stores, for example, information on the VMM 3, the program and data of the OS and the like of each VM, and a table used in the processes which will be described hereafter.

The control unit 12 is an arithmetic processing unit (e.g., a CPU) which reads and executes a program stored in the storage apparatus 17 or the like for implementing the processes described hereafter.

The program for implementing the processes described in an embodiment described hereafter may be provided from the program-provider side via a communication network 20 and the communication I/F 14 and then stored in, for example, the storage apparatus 17. The program for implementing the processes described in an embodiment described hereafter may also be stored in a transportable recording medium which is commercially available and commonly used. In this case, this transportable recording medium may be installed on the reading apparatus 18 so that the control unit 12 can read and execute the program. Various storage apparatuses, such as a CD-ROM, a flexible disk, an optical disk, a magnetic optical disk, an IC card, and a USB memory apparatus may be used as the transportable recording medium. The program stored in such a recording medium is read by the reading apparatus 18.

A keyboard, a mouse, an electronic camera, a web camera, a microphone, a scanner, a sensor, a tablet, a touch panel, and the like may be used as the input equipment 22. A display, a printer, a speaker, and the like may be used as the output equipment 21. The network 20 may be a communication network such as the internet, a LAN, a WAN, an exclusive line communication network, a cable line communication network, or a radio communication network.

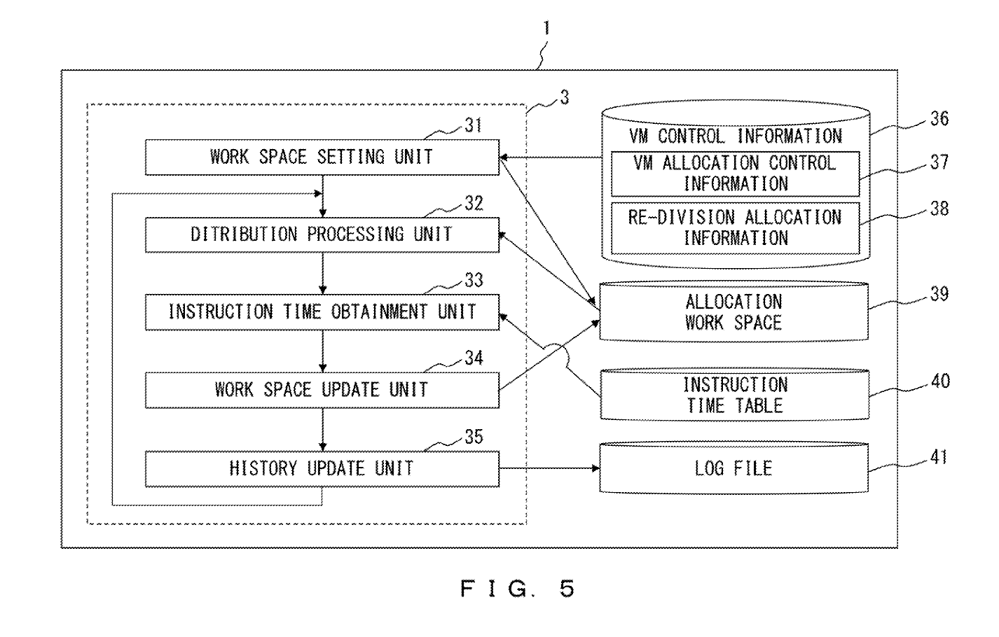

FIG. 5 illustrates an example of a functional block diagram of the computing machine 1 in accordance with the first embodiment. The computing machine 1 includes a VMM 3, a control information storage unit 36, an allocation work space 39, and an instruction time table 40. The VMM 3 includes a work space setting unit 31, a distribution processing unit 32, an instruction time obtainment unit 33, a work space update unit 34, and a history update unit 35. The workspace setting unit 31 functions as the VM setting unit 5 and the sub VM setting unit 6. The distribution processing unit 32, the instruction time obtainment unit 33, the work space update unit 34, and the history update unit 35 together function as the VMM control unit 7.

The control information storage unit 36 stores VM control information. The VM control information is an information group used to manage and control each VM, and it includes VM allocation control information 37 and re-division allocation information 38. The VM allocation control information 37 is information used to allocate the resource of the computing machine 1 to each VM. The re-division allocation information 38 is information used to further divide one VM into a plurality of VMs (i.e., sub VMs) and manage and control them. The VM allocation control information 37 and the re-division allocation information 38 are information stored via the manager inputting it with the input apparatus 22 or are stored information input via the network 20.

The computing machine 1 also includes a user management table (not illustrated). Information for identifying a VM and a sub VM used by each user is registered in the user management table. Information registered in the user management table is information stored via the manager inputting it with the input apparatus 22 or is stored information input via the network 20. The user management table may be associated with VM control information (VM allocation control information 37 and re-division allocation information 38). As a result, VMs and/or sub VMs may be managed for each user.

The allocation work space 39 is a work space on a real memory in which information used to allocate the resource of the computing machine 1 to each VM and/or each sub VM during a process currently executed is temporarily expanded. Information such as VM control information (VM allocation control information 37 and re-division allocation information 38) is expanded in the allocation work space 39.

The instruction time table 40 stores processing time of an instruction to be executed by each VM and/or each sub VM.

The work space setting unit 31 sets, to the allocation work space 39, VM control information extracted from the control information storage unit 36. The work space setting unit 31 also sets, to the allocation work space 39, processing order information for managing the processing order of VMs currently used.

The distribution processing unit 32 adjusts the distribution of the CPU processing capacity to VMs and/or sub VMs in accordance with a “system usage” contained in the VM control information set to the allocation workspace 39. The distribution processing unit 32 also calculates and determines the order of allocating processes to each VM or each sub VM.

The instruction time obtainment unit 33 obtains, from the instruction time table 40, the time needed to process an instruction to be given to a VM or sub MV to which a process has been allocated by the distribution processing unit 32.

The work space update unit 34 updates the VM control information expanded in the allocation work space 39, processing order information, and the like by using the content calculated and determined by the distribution processing unit 32 and the instruction time obtained by the instruction time obtainment unit 33.

The history update unit 35 stores the content calculated and determined by the distribution processing unit 32 in the storage apparatus 17 as a history (i.e., a log file 41).

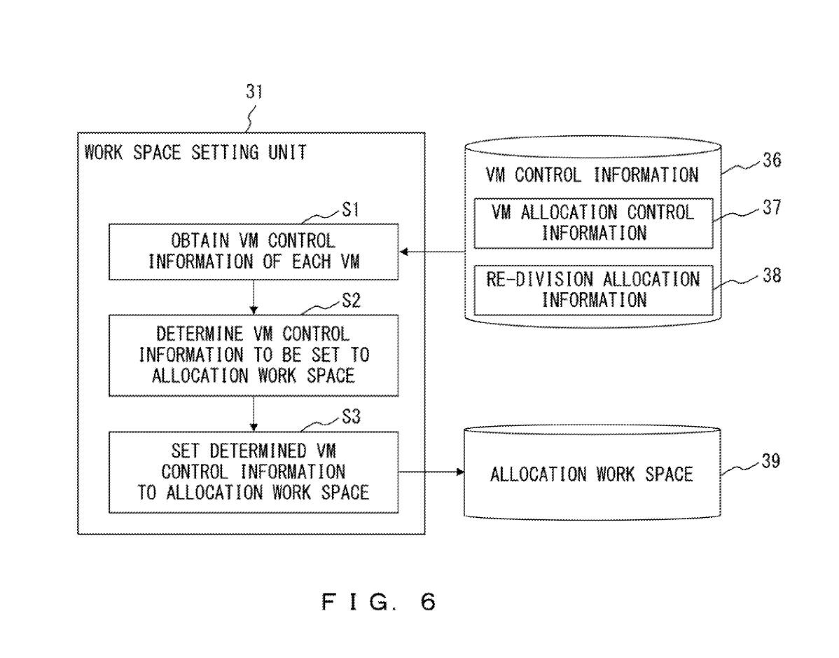

FIG. 6 illustrates an example of processing details of a work space setting unit 31 in accordance with the first embodiment. The workspace setting unit 31 obtains VM control information of each VM 4 from the control information storage unit 36 (S1). The work space setting unit 31 determines VM control information to be set to the allocation work space 39 from among the obtained VM control information (S2). The work space setting unit 31 sets the determined VM control information to the allocation work space 39 (S3).

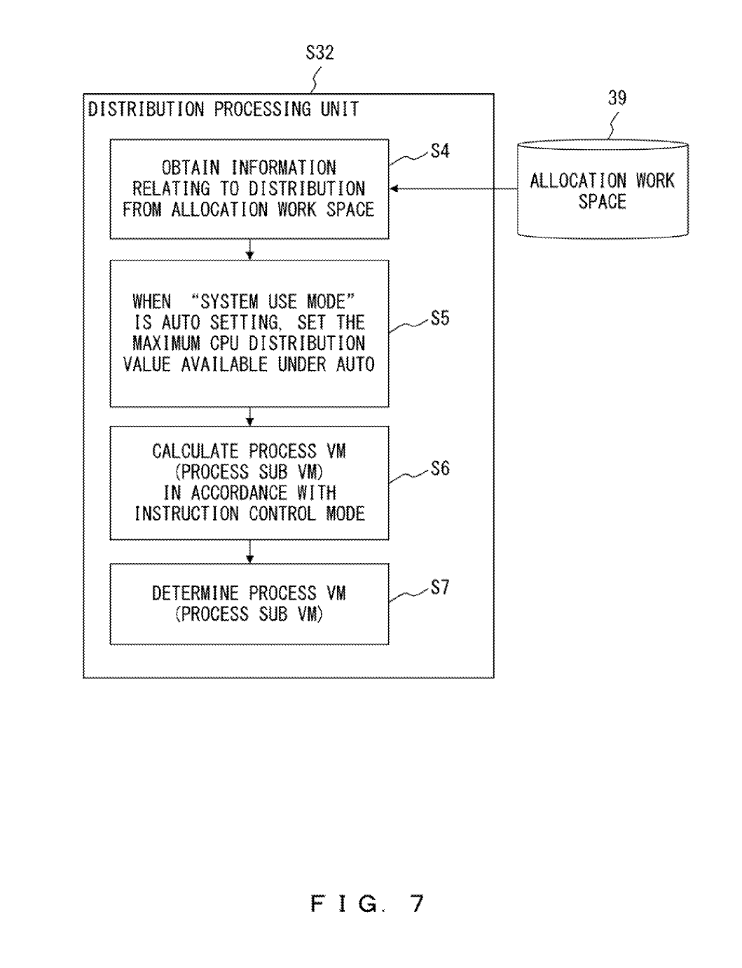

FIG. 7 illustrates an example of processing details of a distribution processing unit 32 in accordance with the first embodiment. The distribution processing unit 32 obtains, from the allocation work space 39, VM control information including information relating to distribution of CPU placement values and the like allocated to each VM (S4).

When the “system usage” of the obtained VM control information is the AUTO (or FREE) setting, the distribution processing unit 32 sets the maximum CPU distribution value of a VM or sub VM that is available under the AUTO (or FREE) setting (S5).

Using an instruction control mode, the distribution processing unit 32 calculates a processing-object VM or sub VM (S6). Here, the instruction control mode is a method for calculating a processing-object VM or sub VM. A sequential distribution process and a consecutive distribution process, which will be described hereinafter, may be examples of the instruction control mode.

The distribution processing unit 32 determines a processing-object VM or sub VM in accordance with the result of the calculation in S6 (S7).

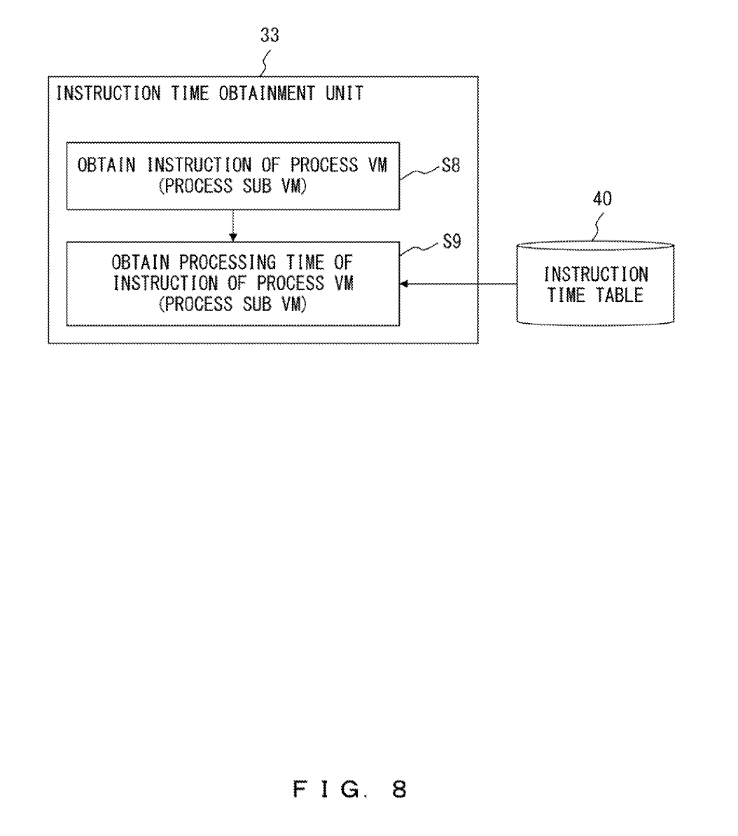

FIG. 8 illustrates an example of processing details of an instruction time obtainment unit 33 in accordance with the first embodiment. The instruction time obtainment unit 33 obtains, from the OS of a VM determined as being a processing object (i.e., a process VM) or the OS of a sub VM determined as being a processing object (i.e., a process sub VM), an instruction of this process VM or process sub VM (S8). The instruction time obtainment unit 33 obtains, from an instruction processing time table 43, the processing time corresponding to the instruction obtained in S8 (S9).

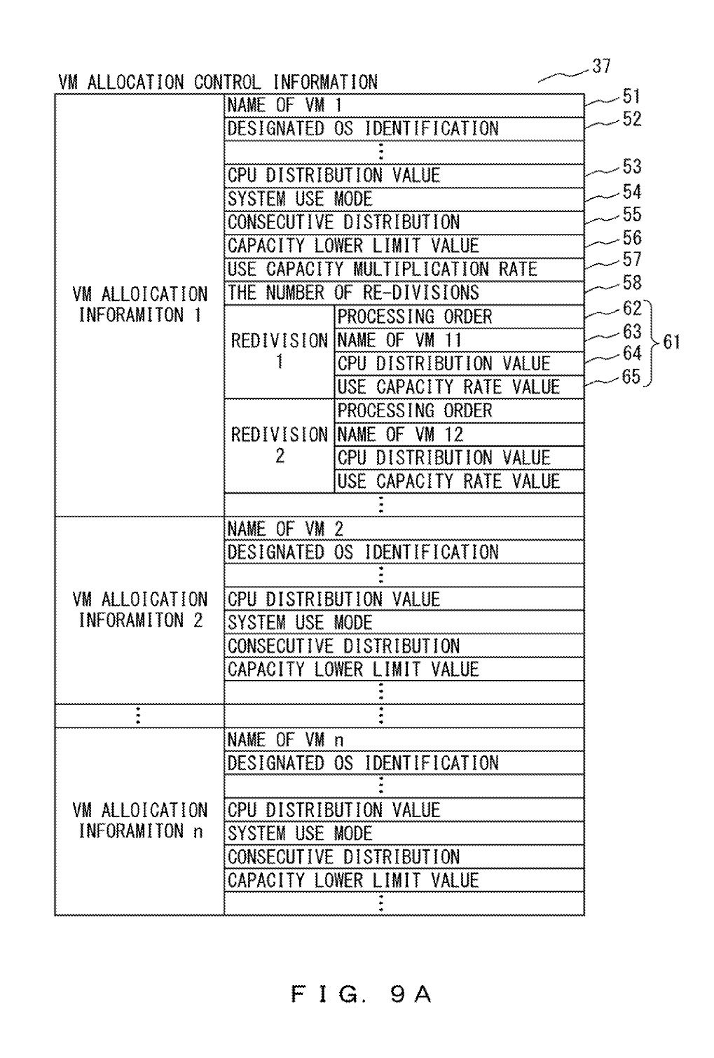

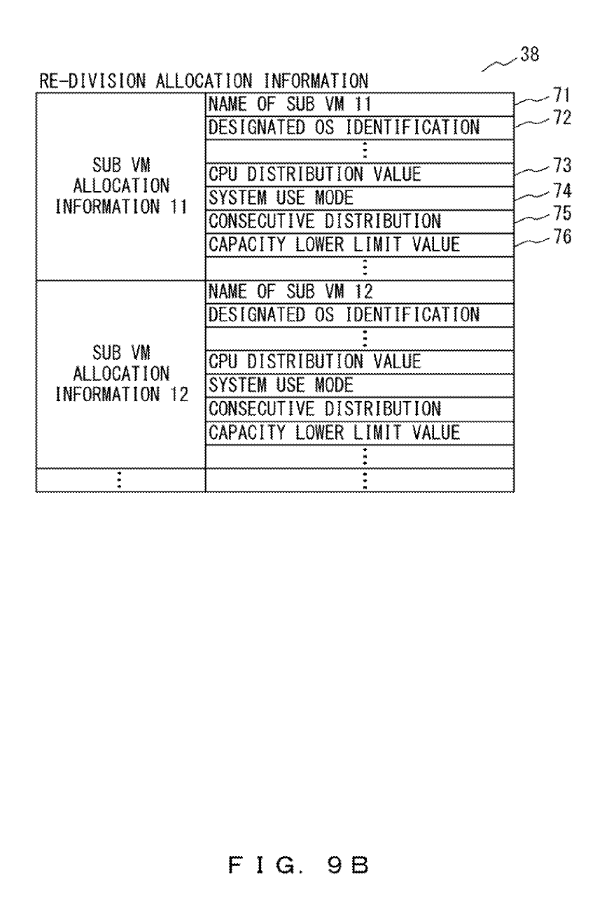

FIGS. 9A and 9B each illustrate an example of VM control information stored by the control information storage unit 36 in accordance with the first embodiment. The control information storage unit 36 includes the VM allocation control information 37 (FIG. 9A) and the re-division allocation information 38 (FIG. 9B) as VM control information. The VM allocation control information 37 and the re-division allocation information 38 store information which was set at the time of system construction and information input via an input apparatus or network. The storage apparatus 17 includes the control information storage unit 36.

A user management table (not illustrated) is also stored in the storage apparatus 17. User identification information for identifying a user, VM identification information for identifying a VM used by the user, sub VM identification information for identifying a sub VM used by the user, and the like are associated and stored in the user management table.

VM allocation information i (i=1 to n) is set in accordance with the number (n) of VMs. Each piece of VM distribution information i includes data items such as “VMi name” 51, “designated OS identification” 52, . . . “CPU distribution value” 53, “system use mode” 54, “consecutive distribution” 55, “capacity lower limit value” 56, “use capacity multiplication rate” 57, “the number of re-divisions” 58, and the like.

The name of VMi (i=1 to n) is stored in the “VMi name” 51. Identification information for identifying an OS used by VMi is stored in the “designated OS identification” 52. The distribution value of the CPU distributed to VMi is stored in the “CPU distribution value” 53. Here, the distribution value of the CPU is expressed as, for example, a percentage (%). The “system usage” 54 stores “FIX” for fixing the CPU distribution value of the CPU distributed to VMi or “AUTO (or FREE)” for dynamically varying the CPU distribution value of the CPU distributed to VMi. The “consecutive distribution” 55 stores information indicating that processing is performed consecutively in the instruction control mode described hereinafter. The “capacity lower limit value” 56 stores the lower limit of the value of the capacity of the CPU distributed to VMi. Here, the capacity lower limit value is expressed as, for example, a percentage (%). The “use capacity multiplication rate” 57 is used in the process described hereinafter. “The number of re-divisions” 58 stores, for example, the number of sub VMij's constructed by further dividing VMi.

When VMi is divided to further generate virtual machines VMij controlled by VMi, the item of “re-division j” 61 is generated in accordance with the number m of the generated VMij's. Re-division information is set to the “re-division j” 61.

Re-division information stored by the “re-division j” 61 includes “processing order” 62, “VMij name” 63, “CPU distribution value” 64, and “use capacity multiplication rate” 65. The “processing order” 62 stores the processing order of VMij. The “VMij name” 63 stores the name of a VMij (i=1 to n, j=1 to m). The “CPU distribution value” 64 stores the CPU distribution value of the CPU distributed to VMij. The “use capacity multiplication rate” 65 is used in the process described hereinafter.

The re-division allocation information 38 includes sub VM allocation information ij of sub MVij corresponding to the “re-division j” 61. Each piece of sub VM allocation information ij includes data items such as “sub VMij name” 71, “designated OS identification” 72, . . . “CPU distribution value” 73, “system use mode” 74, “consecutive distribution” 75, and “capacity lower limit value” 76.

The name of a sub VMij is stored in the “sub VMij name” 71. Identification information for identifying an OS used by sub VMij is stored in the “designated OS identification” 72. The distribution value of the CPU distributed to sub VMij is stored in the “CPU distribution value” 73. The “system usage” 74 stores “FIX” for fixing the CPU distribution value of the CPU distributed to sub VMij or “AUTO (or FREE)” for dynamically varying the CPU distribution value of the CPU distributed to sub VMij. The “consecutive distribution” 75 stores information indicating that processing is performed consecutively in the instruction control mode described hereinafter. The “capacity lower limit value” 76 stores the lower limit of the value of the capacity of the CPU distributed to sub VMij.

By associating a user management table (not illustrated) with VM allocation control information 37 and the re-division allocation information 38 by using “VMi name” as a key, a VM and/or sub VM of each user may be managed.

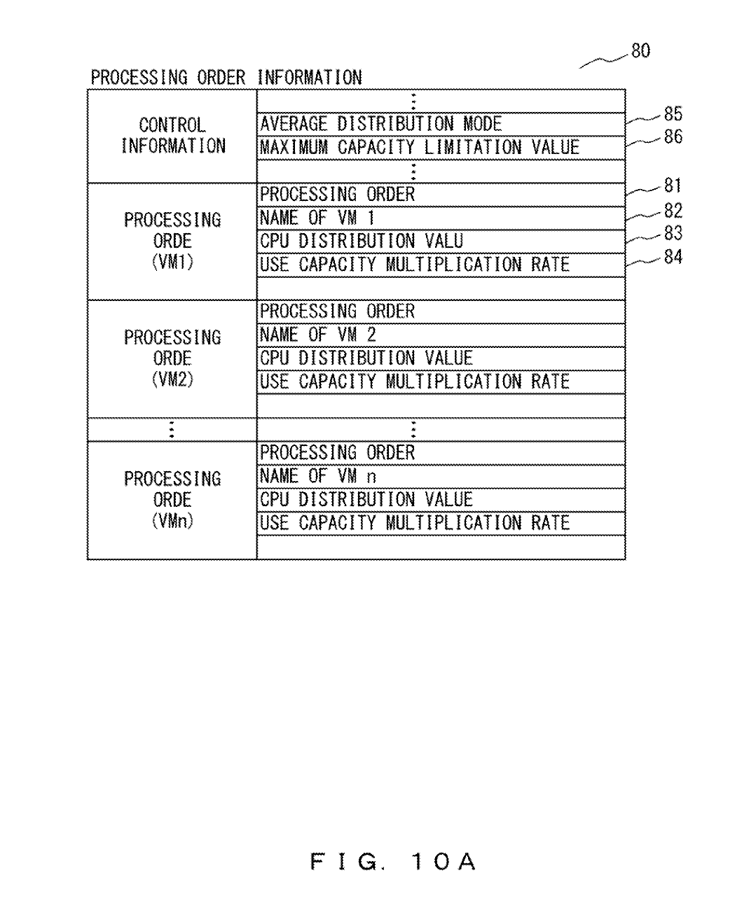

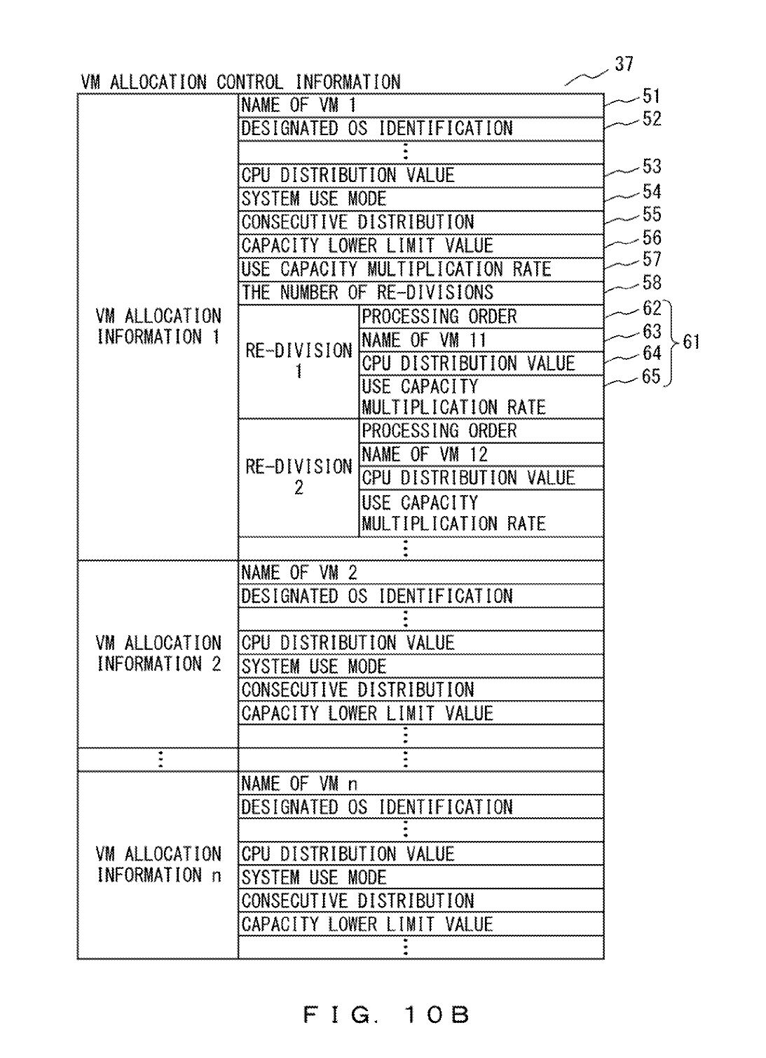

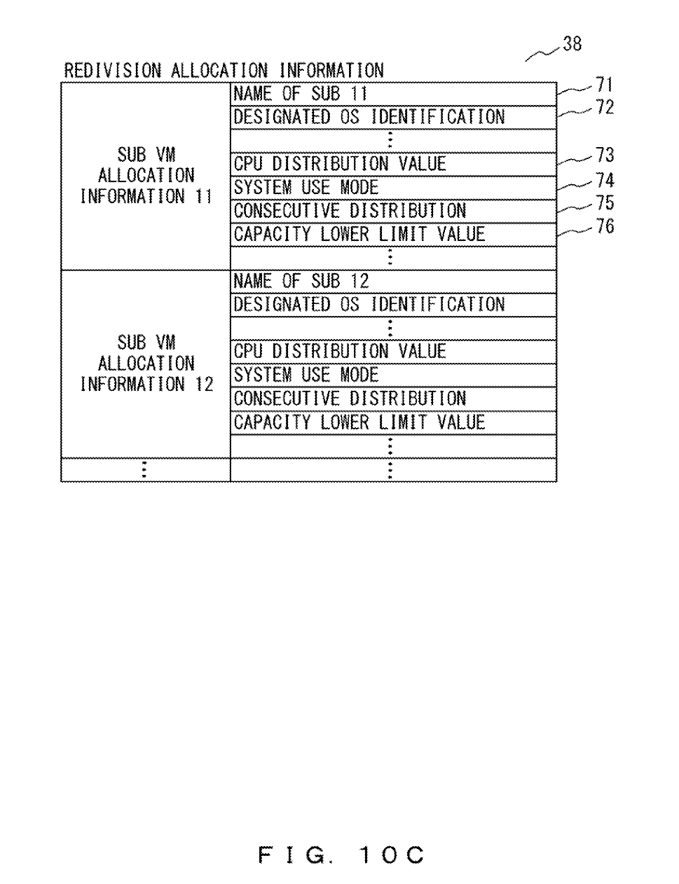

FIGS. 10A, 10B and 10C are each a diagram illustrating information expanded in an allocation work space in accordance with the first embodiment. As an example, processing order work information 80 (FIG. 10A), VM allocation control information 37 (FIG. 10B), and re-division allocation information 38 (FIG. 10C) are expanded in the allocation work space 39.

At the time of an initial program load (IPL), the work space setting unit 31 reads the contents of VM control information (VM allocation control information 37 and re-division allocation information 38) from the control information storage unit 36 and expands it within the allocation work space 39.

In this case, the work space setting unit 31 generates processing order information 80 for the allocation work space 39. The processing order information 80 is work information for managing the status of use of VMi (i=1 to n) currently executed.

The processing order information 80 includes “control information” as header information and processing order (VMi) information for a VMi subsequently in use. The “control information” includes “average distribution mode” 85 and “maximum capacity limitation value” 86. The “average distribution mode” 85 is an item used to determine an instruction control mode. The “maximum capacity limitation value” 86 is an item used when a capacity lower limit value application process is performed.

The processing order (VMi) information includes “processing order” 81, “VMi name” 82, “CPU distribution value” 83, “use capacity multiplication rate” 84, and the like. The “processing order” 81 stores processing orders of VMs currently operated. The “VMi name” 82 stores the name of a VMi. The “CPU distribution value” 83 stores the distribution value of the CPU distributed to the VMi. The “use capacity multiplication rate” 84 is a work item used to calculate the processing distribution.

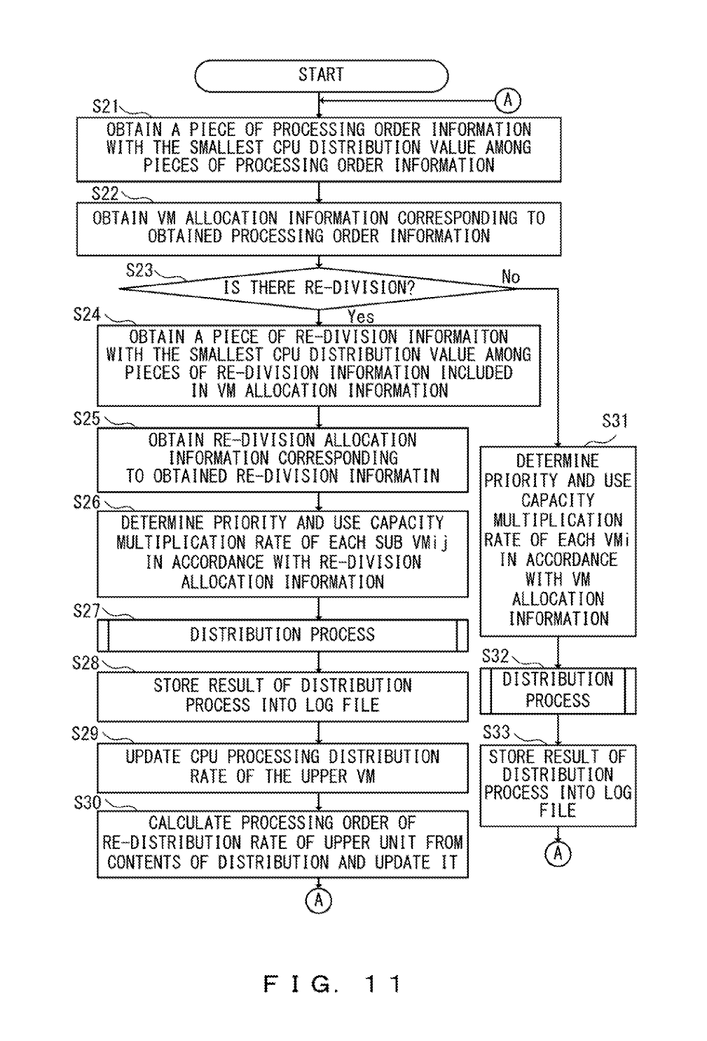

The distribution processing unit 32, the instruction time obtainment unit 33, the work space update unit 34, and the history update unit 35 use VM control information and processing order information 80 expanded within the allocation work space 39 to update the status of use of the CPU which changes in accordance with operations of each VMi and sub VMij. This updating process will be described with reference to FIG. 11.

FIG. 11 illustrates an example of a flowchart which indicates a procedure for distributing processes, the procedure being executed by the control unit 12 in accordance with the first embodiment. At startup of the computing machine 1, the control unit 12 reads the program of VMM 3 from a storage apparatus and executes it.

As a result, in accordance with the program of the VMM 3, the control unit 12 functions as the workspace setting unit 31, the distribution processing unit 32, the instruction time obtainment unit 33, the work space update unit 34, and the history update unit 35, and performs the following processes. That is, the control unit 12 executes the flow in FIG. 11 using VM control information (VM allocation control information 37 and re-division allocation information 38) and processing order information 80 expanded within the allocation work space 39 described with reference to FIGS. 10A, 10B and 10C.

First, the control unit 12 obtains processing order information having the smallest CPU distribution value among the processing order information 80 expanded within the allocation work space 39 (S21). In the present embodiment, the VM with the smallest CPU distribution value is initially processed in S21; however, the order is not limited to this. As an example, the control unit 12 may initially process the VM with the largest CPU distribution value.

Next, the control unit 12 refers to the “VMi name” of the processing order information obtained in S21 and obtains, from the VM allocation control information 37, VM allocation information i associated by the “VMi name” (S22).

The control unit 12 determines whether a value has been set to “the number of re-divisions” of the VM allocation information i obtained in S22 or whether “the number of re-divisions” which has been set is as large as or larger than two (S23). When a value has not been set to “the number of re-divisions” of the VM allocation information i obtained in S22 or when “the number of re-divisions” which has been set is smaller than two (“No” in S23), the control unit 12 performs the following processes. That is, the control unit 12 determines the priority and the use capacity multiplication rate from VM allocation information i for each VM expanded within the allocation work space 39. Here, the priority is a value which is set in accordance with the CPU distribution value. The use capacity multiplication rate for each VM (or sub VM) is a value represented by the following formula (1).

Use capacity multiplication rate=Entire capacity/VM (or sub VM) set value×processing capacity setting value (1)

Here, the VM (or sub VM) setting value corresponds to a CPU distribution value relating to a VM (or sub VM). The entire capacity corresponds to the total CPU distribution value. The processing capacity setting value is a value which is set in accordance with the processing capacity of each VMi or sub VMij.

Using the priority and the use capacity multiplication rate determined in S31, the control unit 12 allocates a processing execution time to each VM (S32). In the distribution process, a process is distributed to each VM in accordance with the instruction control mode. The distribution process will be described hereinafter.

The control unit 12 stores the result of the distribution process in S32 into a log file (S33). The controlling process then returns to S21.

When a value is set to “the number of re-divisions” of VM allocation information i obtained in S22 or when “the number of re-divisions” which has been set is as large as or larger than two (“Yes” in S23), the control unit 12 performs the following processes. That is, the control unit 12 obtains the re-division information with the smallest CPU distribution value among re-division information 61 included in the VM allocation information i obtained in S22 (S24).

The control unit 12 refers to the “VMij name” of the re-division information obtained in S24 and obtains, from re-division allocation information 38, sub VM allocation information ij associated by this “VMij name” (S25).

The control unit 12 determines a priority and a use capacity multiplication rate from the sub VM allocation information ij for each sub VMij expanded within the allocation work space 39 (S26). Processes performed in S26 are the same as those in S31.

Using the priority and the use capacity multiplication rate determined in S26, the control unit 12 allocates a processing execution time to each VM (S27). Processes performed in S27 are the same as those in S32.

The control unit 12 stores the result of the distribution process in S27 into a log file (S28). The controlling process then returns to S21.

The control unit 12 updates the “CPU distribution value” 53 of the VM allocation information i relating to the upper VMi of the sub VMij to which the distribution process has been applied, wherein the VM allocation information i is VM allocation information i expanded within the allocation work space 39 (S29). Upon the execution of the processing of the sub VMij, the control unit 12 updates the distribution value which is based on the CPU processing capacity of the upper VMi that varies in accordance with variation in the CPU processing capacity of this sub VMij.

The control unit 12 updates the CPU distribution value of processing order information of a VMi corresponding to the VM allocation information i updated in S29, and it further updates the processing order, wherein the processing order information is processing order information expanded within the allocation work space 39 (S30).

Details of the distribution processes in S27 and S32 will be described in the following. The distribution processes are executed in accordance with the instruction control mode. A sequential distribution process and a consecutive distribution process may be examples of the instruction control mode. These processes will each be described in detail in the following.

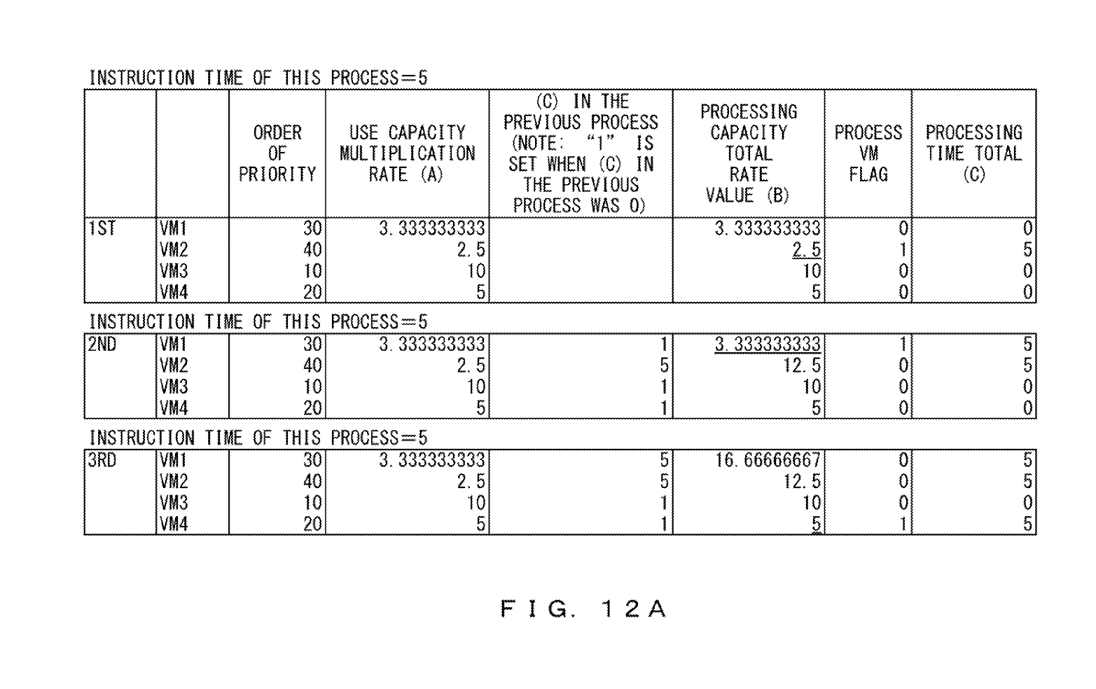

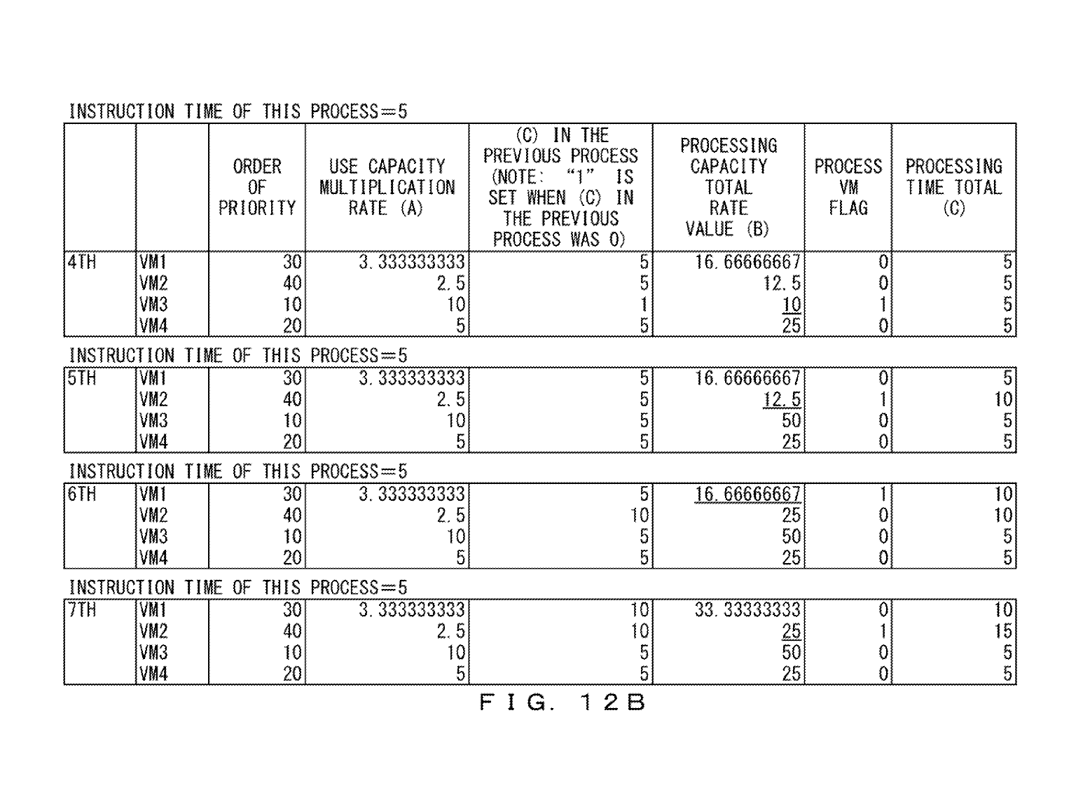

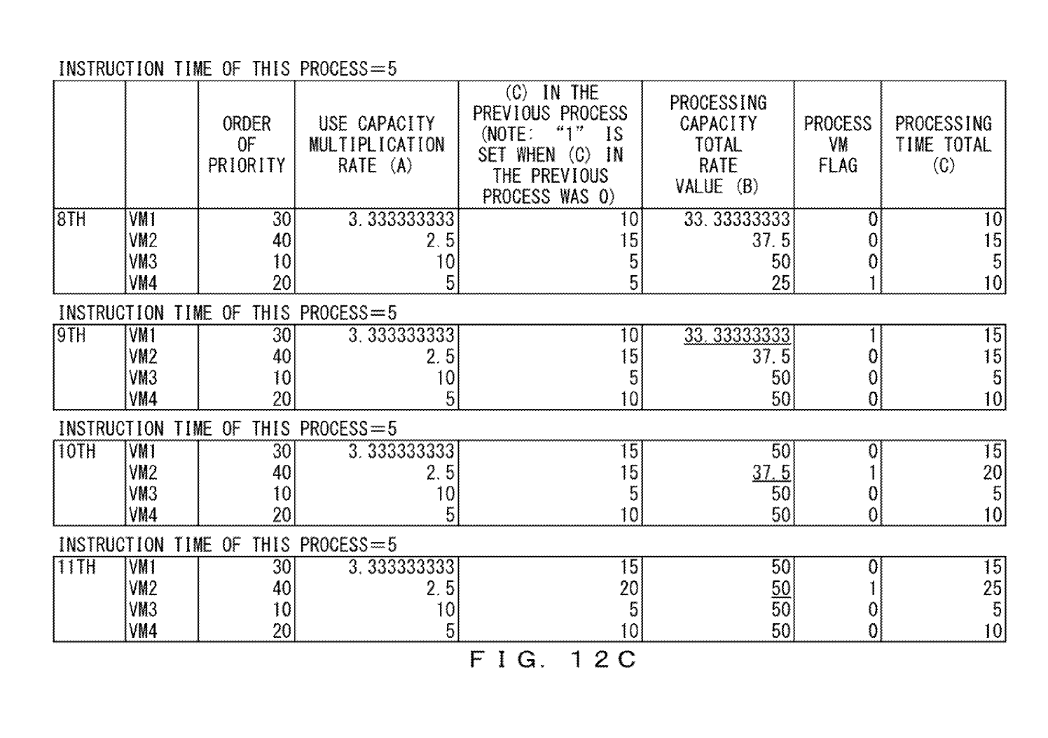

FIGS. 12A, 12B and 12C are each a diagram illustrating a sequential distribution process (fix) in accordance with the first embodiment. In the sequential distribution process (fix), the processing times are fixed, and processes are allocated to VMs or sub VMs equally in accordance with the CPU distribution value. FIGS. 12A, 12B and 12C illustrate the sequential distribution process performed on each VM, but this process is similar to the sequential distribution process performed on each sub VM.

In FIGS. 12A, 12B and 12C, the priority is set in accordance with the distribution value of the CPU. The use capacity value is a value obtained from the formula (1) described above. Let “100” be the entire capacity in the formula (1). Let “1” be the processing capacity setting value. In the example in FIGS. 12A, 12B and 12C, “5” is the instruction time of each process.

FIGS. 12A, 12B and 12C illustrate the distribution process of VMs (VM 1, VM 2, VM 3 and VM 4) as examples, but the distribution process of sub VMs may also be performed in the same manner as VMs.

Let 30%, 40%, 10% and 20% be the CPU distribution values of VM 1, VM 2, VM 3 and VM 4, respectively. In this case, the priorities of VM 1, VM 2, VM 3 and VM 4 are 30, 40, and 20.

Use capacity multiplication rate (A) of VM 1 is 100/30×1=3.3333 . . . in accordance with formula (1). Use capacity multiplication rate (A) of VM 2 is 100/40×1=2.5 in accordance with formula (1). Use capacity multiplication rate (A) of VM 3 is 100/10×1=10 in accordance with formula (1). Use capacity multiplication rate (A) of VM 4 is 100/20×1=5 in accordance with formula (1).

In the first distribution process, processing capacity total rate values (B) are the same as use capacity multiplication rates (A). The control unit 12 detects a VM with the smallest value of the processing capacity total rate values and sets “1” as the process VM flag of the detected VM. The VM with the process flag is a process VM which is the processing object. The process VM obtains and executes the instruction processing. After the processing of the process VM, the processing time=5 is added to processing time total (C).

In the second distribution process, the control unit 12 multiplies the use capacity multiplication rate (A) of each VM by the previous processing time total (C) to calculate processing capacity total rate values (B). In this case, when the value of the previous processing time total (C) is 0, the control unit 12 multiplies the use capacity multiplication rate (A) of each VM by “1” to calculate processing capacity total rate values (B). The control unit 12 detects a VM with the smallest value of the processing capacity total rate values (B) and sets “1” as the process VM flag of the detected VM. The VM with the process VM flag is a process VM which is the processing object. The process VM obtains and executes the instruction processing. After the processing of the process VM, the processing time=5 is added to the processing time total (C).

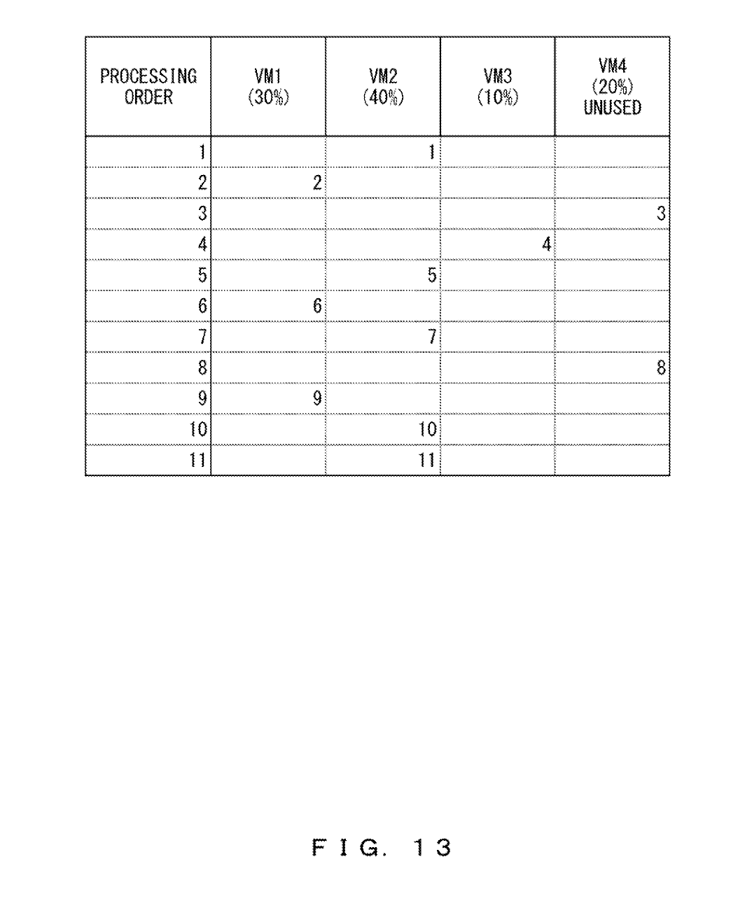

The aforementioned processes are repeated in the third and following distribution processes. The results of the processes are illustrated in FIG. 13. The processing capacity total rate values of the VMs become identical with each other in the eleventh process. In this case, the VM with the highest priority is set as the process VM. Accordingly, VM 2 becomes the process VM in the eleventh process.

FIG. 13 illustrates a result of the sequential distribution process (fix) illustrated in FIG. 12. The result indicated in FIG. 13 is obtained by assigning the numbers in the order in which the process VM flag is set in FIG. 12. Accordingly, the processing control is allocated to VMs in this order.

In the sequential distribution process (fix), as described above, a time sharing system (TSS) mode is employed in which VMs or sub VMs to be executed are sequentially switched. The sequential distribution process may be employed for, for example, online processes (i.e., processes in which great importance is not attached to the throughput).

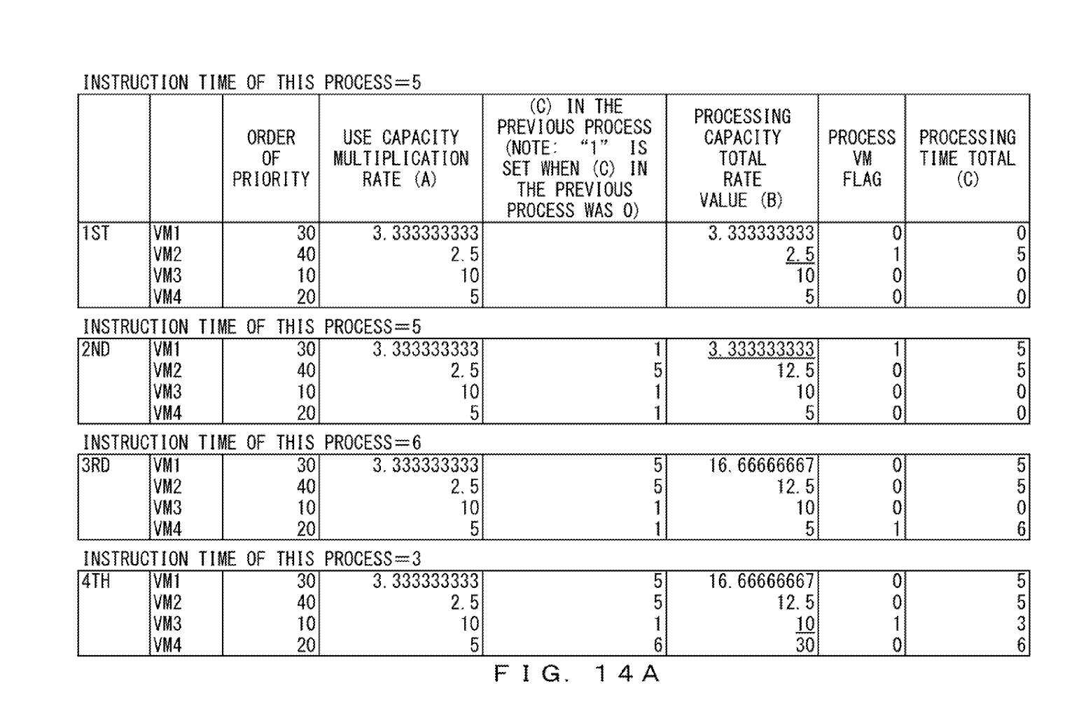

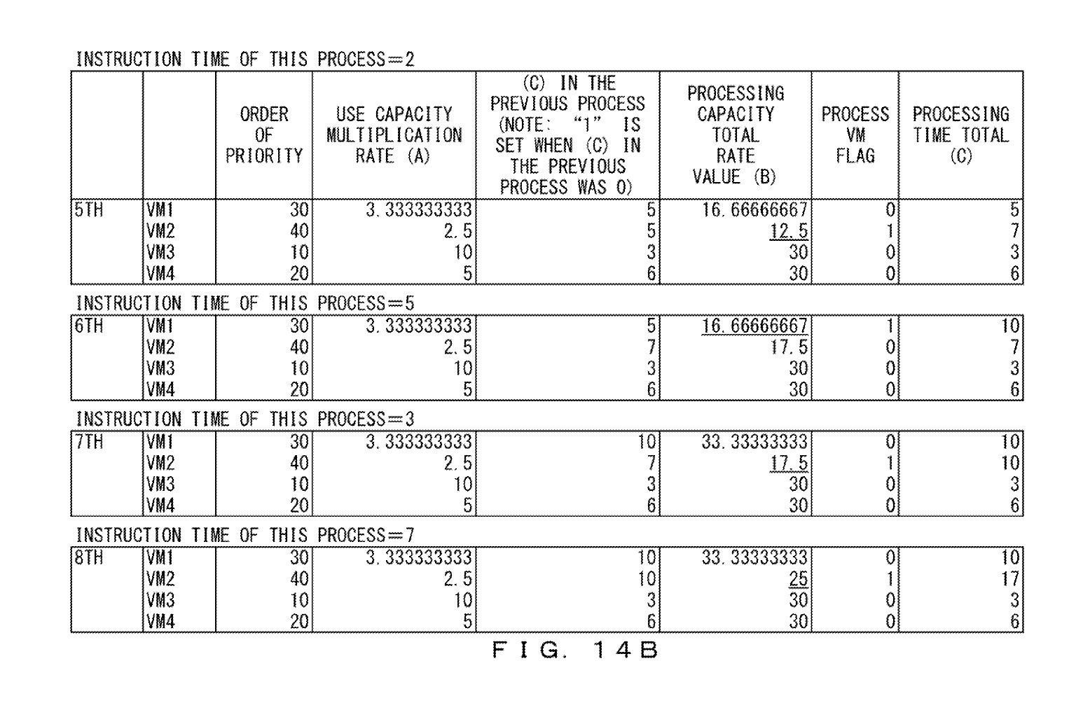

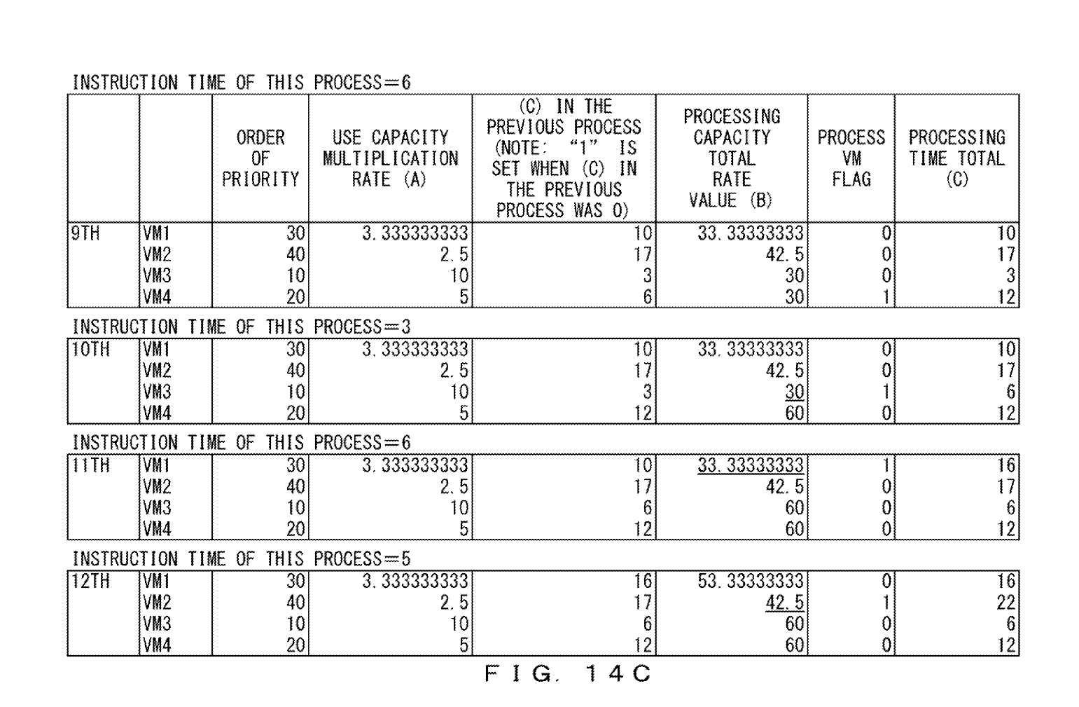

FIGS. 14A, 14B and 14C each illustrate a diagram illustrating a sequential distribution process (an average distribution mode) in accordance with the first embodiment. The sequential distribution process (an average distribution) in FIGS. 14A, 14B and 14C is different from the sequential distribution process (fix) in FIG. 12 in that instruction times are not fixed. In the sequential distribution process in FIGS. 14A, 14B and 14C, as much as possible, the completion times of processes performed during a predetermined number of operations are leveled out in accordance with the CPU processing capacity. Although FIGS. 14A, 14B and 14C each illustrate a distribution process on VMs (VM 1, VM 2, VM 3 and VM 4) as an example, a distribution process on sub VMs may be performed in the same manner.

In the first distribution process, processing capacity total rate values (B) are the same as use capacity multiplication rates (A). The control unit 12 detects a VM with the smallest value of the processing capacity total rate values (B) and sets “1” as the process VM flag of the detected VM. The VM with the process flag is a process VM which is the processing object. The process VM obtains and executes the instruction processing. After the processing of the process VM, the processing time=5 is added to the processing time total (C).

In the second distribution process, the control unit 12 multiplies the use capacity multiplication rate (A) of each VM by the previous processing time total (C) to calculate processing capacity total rate values (B). In this case, when the value of the previous processing time total (C) is 0, the control unit 12 multiplies use capacity multiplication rate (A) of each VM by “1” to calculate processing capacity total rate values (B). The control unit 12 detects a VM with the smallest value of the processing capacity total rate values (B) and sets “1” as the process VM flag of the detected VM. The VM with the process flag is a process VM which is the processing object. The process VM obtains and executes the instruction processing. After the processing of the process VM, the processing time=5 is added to the processing time total (C).

In the third distribution process, the control unit 12 multiplies the use capacity multiplication rate (A) of each VM by the previous processing time total (C) to calculate processing capacity total rate values (B). The control unit 12 detects a VM with the smallest value of the processing capacity total rate values (B) and sets “1” as the process VM flag of the detected VM. The VM with the process flag is a process VM which is the processing object. The process VM obtains and executes the instruction processing. After the processing of the process VM, the processing time=6 is added to the processing time total (C).

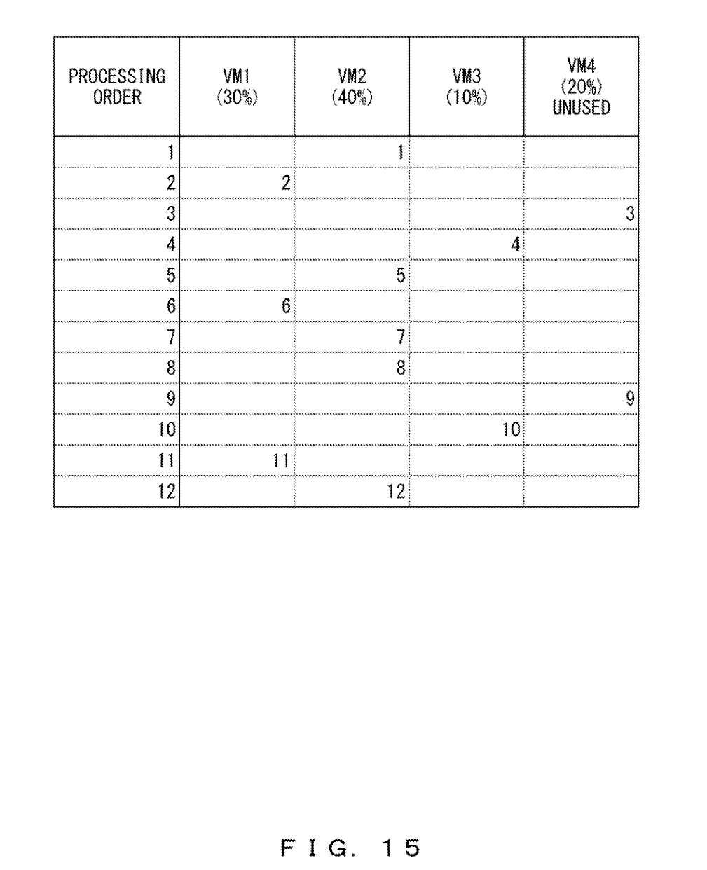

The aforementioned processes are repeated in the fourth and following distribution processes. The results of the processes are illustrated in FIG. 15. In the ninth process, the identical processing capacity total rate values of VM 3 and VM 4 are the smallest processing capacity total rate value. In this case, the VM with the highest priority is set as the process VM. Accordingly, VM 4 becomes the process VM in the ninth process.

FIG. 15 illustrates a result of the sequential distribution process (an average distribution mode) illustrated in FIGS. 14A, 14B and 14C. The result indicated in FIG. 15 is obtained by assigning the numbers in the order in which the process VM flag is set in FIGS. 14A, 14B and 14C. Accordingly, the processing control is allocated to VMs in this order.

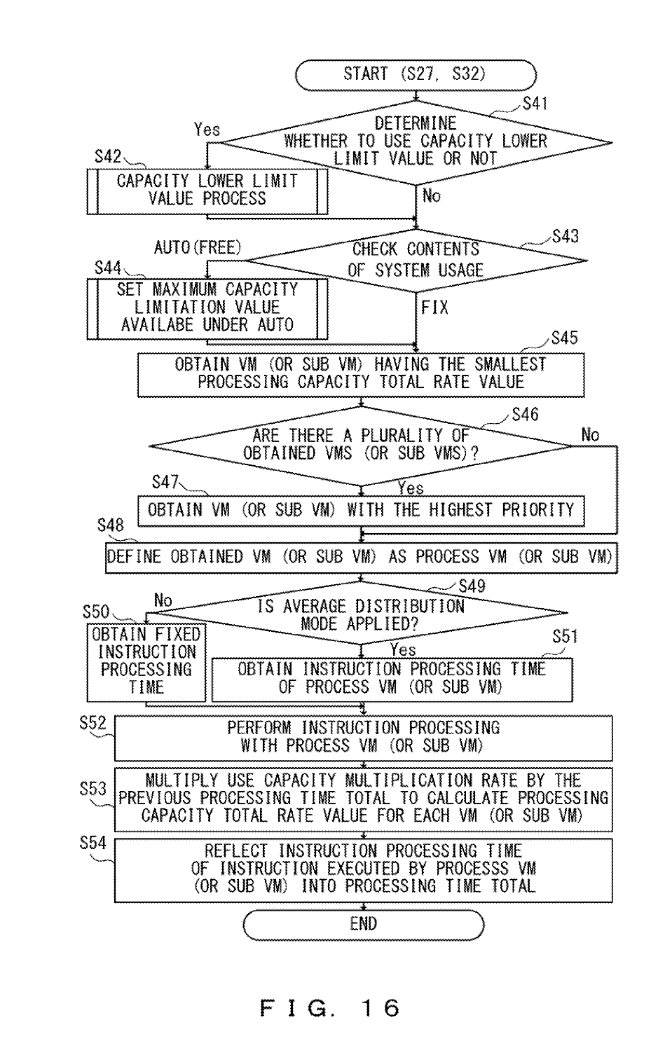

FIG. 16 illustrates an example of the flow of the sequential distribution process in accordance with the first embodiment. The flow indicated in FIG. 16 is the flow of each of the sequential distribution processes illustrated in FIGS. 12 to 15. When the flow in FIG. 16 is called up as the process of S32 in FIG. 11, the control unit 12 executes the flow in FIG. 16 on a VM by VM basis. When the flow in FIG. 16 is called up as the process of S27 in FIG. 11, the control unit 12 executes the flow in FIG. 16 on a sub-VM by sub-VM basis.

First, the control unit 12 determines whether to perform a capacity lower limit value application process or not in accordance with preset information (S41). The capacity lower limit value application process (S42) will be described hereinafter. When the capacity lower limit value application process is not performed (“No” in S41), the control unit 12 reads a “system use mode” from each piece of VM allocation information i used in S31 or each piece of sub VM allocation information ij used in S26.

When “AUTO (or FREE)” is set as the “system use mode”, the control unit 12 sets, as a CPU distribution value, the maximum capacity limitation value which is available under the AUTO setting (S44).

In particular, in the distribution process which is performed on a VM by VM basis, the control unit 12 sets the solution of the formula “100(%)−(CPU distribution value of currently unused VM to which the FIX setting has been applied)×h (h: integer)” to control information of processing order information as the “maximum capacity limitation value”. “h” represents the number of currently unused VMs to which the FIX setting has been applied. The control unit 12 sets the “maximum capacity limitation value” to the “CPU distribution value” 53 of VM allocation information expanded within the allocation work space 39 and “CPU distribution value” 83 of processing order information expanded within the allocation work space 39. As a result, VMs to which the AUTO setting has been applied may use the CPU processing capacity of currently unused VMs to which the FIX setting has been applied.

In the distribution process which is performed on a sub-VM by sub-VM basis, the control unit 12 sets the solution of the formula “100(%)−(CPU distribution value of currently unused sub VM to which the FIX setting has been applied)×h (h: integer) to control information included in processing order information as the “maximum capacity limitation value”. “h” represents the number of currently unused VMs to which the FIX setting has been applied. The control unit 12 sets the “maximum capacity limitation value” to the “CPU distribution value” 73 of sub VM allocation information expanded within the allocation work space 39 and the “CPU distribution value” 64 of the re-division information 61 included in the VM allocation information. As a result, sub VMs to which the AUTO setting has been applied may use the CPU processing capacity of currently unused sub VMs to which the FIX setting has been applied.

When the process of S44 is finished or when “FIX” is set as the “system use mode” in S43, the control unit 12 obtains a VM (or sub VM) with the smallest processing capacity total rate value (S45). When a plurality of VMs (or sub VMs) are obtained in S45 (“Yes” in S46), the control unit 12 obtains one or more of these obtained VMs (or sub VMs) with the highest priority (S47).

The control unit 12 defines the VM (or process sub VM) obtained in S46 or S47 as a process VM (or process sub VM) (S48).

The control unit 12 determines whether a distribution mode included in control information of the processing order information 80 is an average distribution mode or not (S49). Here, the control unit 12 determines whether the distribution mode is the average distribution mode or not by determining whether the “average distribution mode” is valid or not with respect to the control information of the processing order information 80.

When the control unit 12 determines in S49 that the distribution mode is not the average distribution mode (“No” in S49), it obtains a preset fixed instruction processing time (S50). When the control unit 12 determines in S49 that the distribution mode is the average distribution mode (“Yes” in S49), it obtains an instruction processing time from the instruction time table 40 by using the defined process VM (or sub VM) as a key (S51).

The control unit 12 causes the process VM (or the process sub VM) to execute the instruction processing (S52).

The control unit 12 multiplies the use capacity multiplication rate by the previous processing time total to calculate a processing capacity total rate value for each VM (or sub VM) (S53). The control unit 12 reflects the instruction processing time of the instruction executed by the process VM (or sub VM) in the processing time total (S54).

As a result, processing to be executed by VMs or sub VMs is distributed in order of the setting of the process VM flag as described above with reference to FIGS. 12 to 15. In the descriptions above, the sequential distribution process was explained as the instruction control mode; however, the instruction control mode is not limited to the sequential distribution process, and hence the consecutive distribution mode or the like may also be used. In the following, the consecutive distribution process as the instruction control mode will be described.

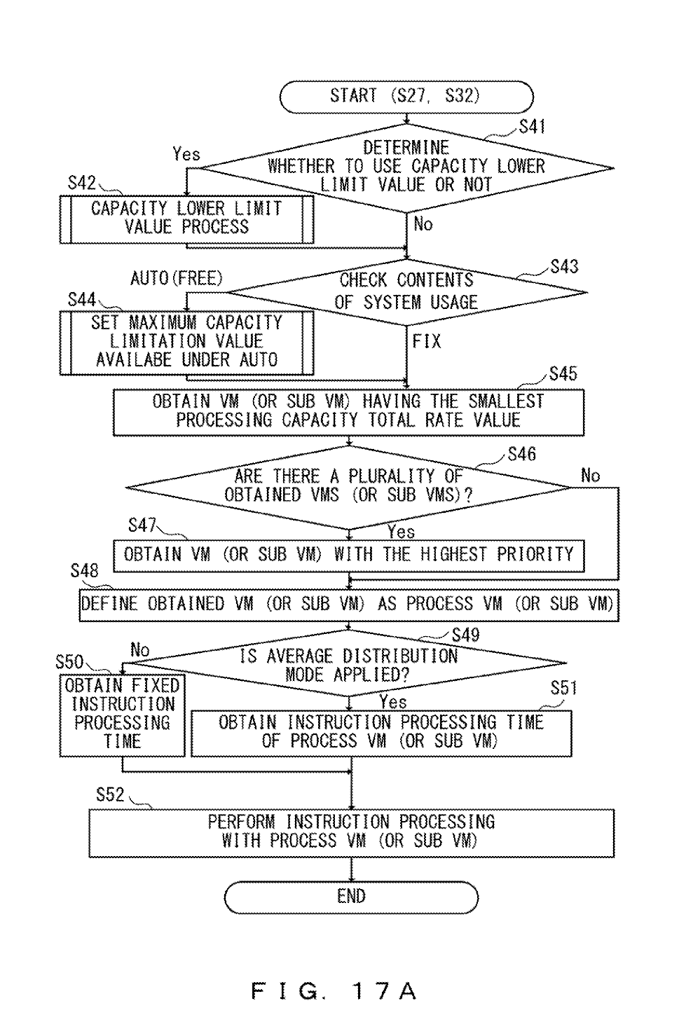

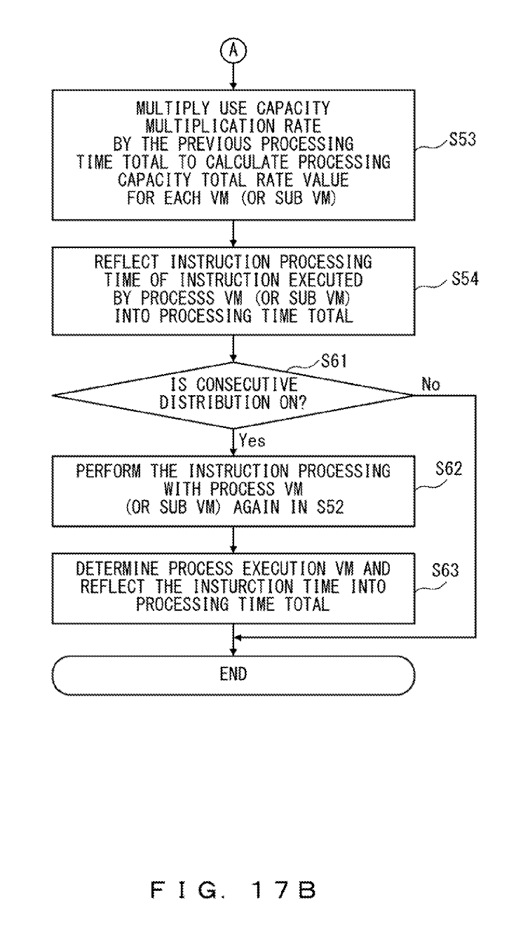

FIGS. 17A and 17B each illustrate an example of the flow of a consecutive distribution process in accordance with the first embodiment. In the consecutive distribution process, a VM (or sub VM) which executed a process in the previous operation is again caused to perform a process, i.e., the process is allocated consecutively. The flow in FIGS. 17A and 17B is the same as the flow in FIG. 16 but further includes S61 to S63.

When the flow in FIGS. 17A and 17B is called up as the process of S32 in FIG. 11, the control unit 12 executes the flow in FIGS. 17A and 17B on a VM by VM basis. When the flow in FIGS. 17A and 17B is called up as the process of S27 in FIG. 11, the control unit 12 executes the flow in FIGS. 17A and 17B on a sub-VM by sub-VM basis.

In a distribution process performed on a VM by VM basis, when the content of the “consecutive distribution” 55 of VM allocation information i expanded within the allocation work space 39 is ON after the process of S54, the control unit 12 causes the VM determined as being the process VM in S52 to execute the instruction processing (S62). The control unit 12 reflects the instruction processing time of the instruction executed by the process VM in the processing time total (S63).

In a distribution process performed on a sub-VM by sub-VM basis, when the content of the “consecutive distribution” 75 of sub VM allocation information ij expanded within the allocation work space 39 is ON after the process of S53, the control unit 12 performs the following processes. That is, the control unit 12 causes the sub VM determined as being the process sub VM in S52 to execute the instruction processing (S62). The control unit 12 reflects the instruction processing time of the instruction executed by the process sub VM in the processing time total (S63). S62 and S63 may be repeated as appropriate in accordance with processing environments.

As described above, the round-robin system is used in the consecutive distribution process. In other words, the consecutive distribution process is performed by mainly using consecutive instructions. When the instruction queue is crowded at one VM or sub MV, two-instruction consecutive processing or the like may be performed. When the instruction queue is not crowded, ten-instruction consecutive processing or the like may be performed. In this way, the processing amount may be changed in accordance with loads on the entire system. The consecutive distribution process may be used for batch-oriented processes (i.e., processes in which great importance is attached to the throughput).

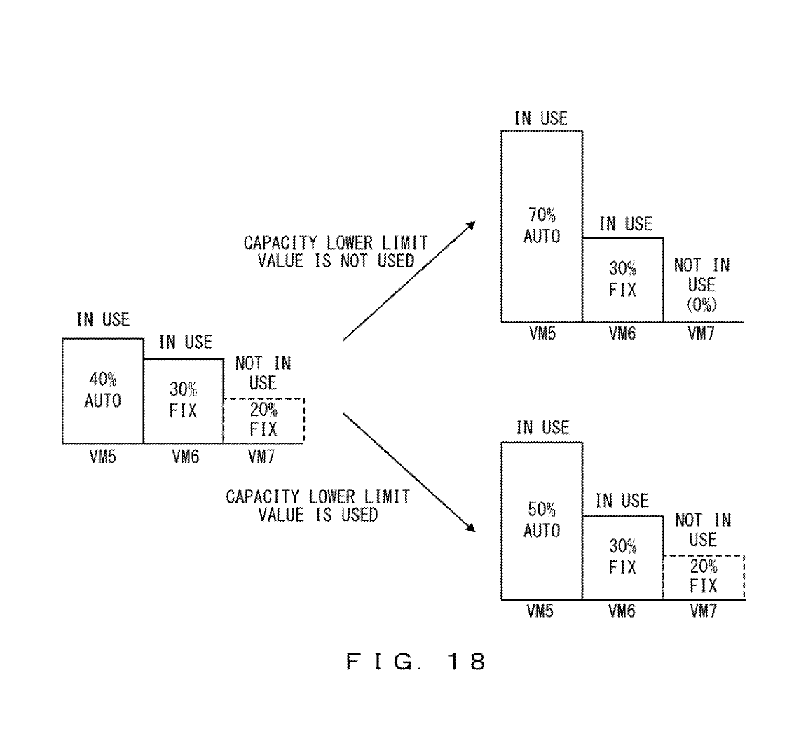

Here, when the process proceeds to “Yes” from S41 in FIG. 16 or FIGS. 17A and 17B, the capacity lower limit value application process is executed. The capacity lower limit value application process will be described in the following with reference to FIG. 18.

FIG. 18 is a diagram illustrating a capacity lower limit value application process in accordance with the first embodiment. FIG. 18 illustrates the capacity lower limit value application process of VMs (VM 5, VM 6, and VM 7) as an example, but the capacity lower limit value application process of sub VMs may also be performed in the same manner.

As an example, assume that VM 5 is in use, its CPU distribution value is 40%, and the AUTO setting has been applied to it; VM 6 is in use, its CPU distribution value is 30%, and the FIX setting has been applied to it; and VM 7 is not in use, its CPU distribution value is 20%, and the FIX setting has been applied to it.

Without the application of the capacity lower limit value application process, VM 5 to which The AUTO setting has been applied will add, to its CPU distribution value, the CPU distribution value distributed to VM 7 which is not in use.

Meanwhile, with the application of the capacity lower limit value application process, the minimum CPU distribution value which has been set as the “capacity lower limit value” will be secured for VM 7 even if VM 7 is not in use. Accordingly, VM 5 to which the AUTO setting has been applied cannot use the CPU distribution value corresponding to the “capacity lower limit value” allocated to VM 7 which is not in use.

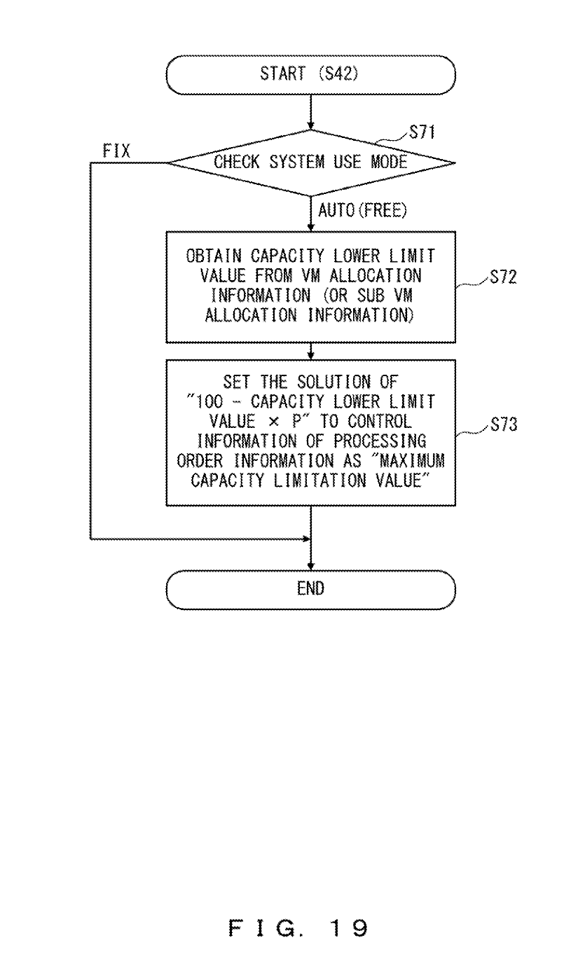

FIG. 19 illustrates an example of the detailed flow of the capacity lower limit value application process (S42). When the process proceeds to “Yes” from S41 in FIG. 16 or FIGS. 17A and 17B, the control unit 12 executes the capacity lower limit value application process (S42). First, the control unit 12 reads a “system use mode” from each piece of VM allocation information i or sub VM allocation information ij.

When “AUTO (or FREE)” is set as the “system use mode” (“Yes” in S71), the control unit 12 performs the following processes (S72). That is, in a distribution process performed on a VM by VM basis, the control unit 12 obtains the “capacity lower limit value” 56 from VM allocation information i. In a distribution process performed on a sub-VM by sub-VM basis, the control unit 12 obtains the “capacity lower limit value” 76 from sub VM allocation information ij.

The control unit 12 sets the solution of the formula “100(%)−capacity lower limit value×p” to control information of the processing order information 80 as a “maximum capacity limitation value” (S73). Here, “p” represents the number of VMs or sub VMs in which a “capacity lower limit value” has been set.

When the “maximum capacity limitation value” is set, then, in S44 in FIG. 16 or FIGS. 17A and 17B, the control unit 12 obtains the “maximum capacity limitation value” from the control information of processing order information 80 and performs the following processes.

That is, in a distribution process performed on a VM by VM basis, the control unit 12 sets the solution of the formula “obtained ‘maximum capacity limitation value’−(CPU distribution value of VM which is not currently used and to which the FIX setting has been applied)×h” to the control information of processing order information as a new “maximum capacity limitation value”. The control unit 12 then sets the “maximum capacity limitation value” to the “CPU distribution value” 53 of VM allocation information expanded within the allocation work space 39 and the “CPU distribution value” 83 of the processing order information expanded within the allocation work space 39. As a result, the CPU processing capacity used by a sub VM in which a capacity lower limit value has been set can be ensured, and, in addition, a VM to which the AUTO setting has been applied can use the CPU processing capacity of the VM which is not currently used and to which the FIX setting has been applied.

In a distribution process performed on a sub-VM by sub-VM basis, the control unit 12 sets the solution of the formula “obtained ‘maximum capacity limitation value’−(CPU distribution value of sub VM which is not currently used and to which the FIX setting has been applied)×h” to the control information of processing order information as a new “maximum capacity limitation value”. The control unit 12 then sets the “maximum capacity limitation value” to the “CPU distribution value” 73 of sub VM allocation information expanded within the allocation work space 39 and the “CPU distribution value” 64 of the re-division information 61 included in VM allocation information. As a result, the CPU processing capacity used by a sub VM in which a capacity lower limit value has been set can be ensured, and, in addition, a sub VM to which the AUTO setting has been applied can use the CPU processing capacity of the sub VM which is not currently used and to which the FIX setting has been applied.

In accordance with the present embodiment, as described above, the resources of a plurality of virtual machines of users may be effectively utilized within the scope of the processing capacities distributed to the users. That is, even when each user uses a sub VM to which the FREE setting has been applied with respect to the CPU capacity and a sub VM for which an upper limit has been set with respect to the CPU capacity, the VMM control unit 7 can control the CPU processing capacity of a plurality of virtual machines for each user within the scope of the processing capacity distributed to each user. In addition, even when the FREE setting is applied with respect to distribution of the CPU processing capacity of sub VMs, the CPU processing capacity cannot be used beyond the CPU processing capacity distributed to each user. Even when a sub VM in which the lower limit of the processing capacity is set is not in use, the processing capacity distributed to this sub VM is ensured so that this sub VM can be used any time it is needed.

Next, a second embodiment will be described. In regard to the second embodiment, a situation will be described in which the first embodiment is applied to a computing machine which uses a multiprocessor. In the second embodiment, like configurations, functions, processes, and the like are indicated by like numerals used in the first embodiment, and hence their descriptions will be omitted.

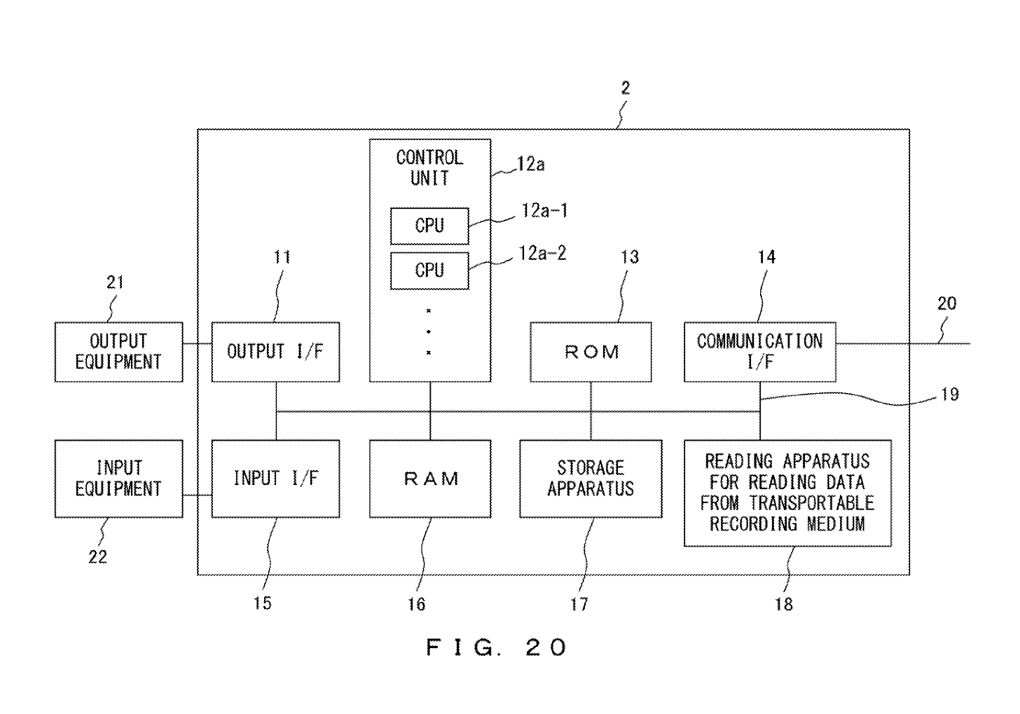

FIG. 20 illustrates an example of a configuration block diagram of hardware 2 of a computing machine 1 in accordance with a second embodiment. In the hardware 2 of the computing machine 1 in FIG. 20, a control unit 12a is provided instead of the control unit 12 in FIG. 4. The control unit 12a is a multiprocessor system including a plurality of CPUs.

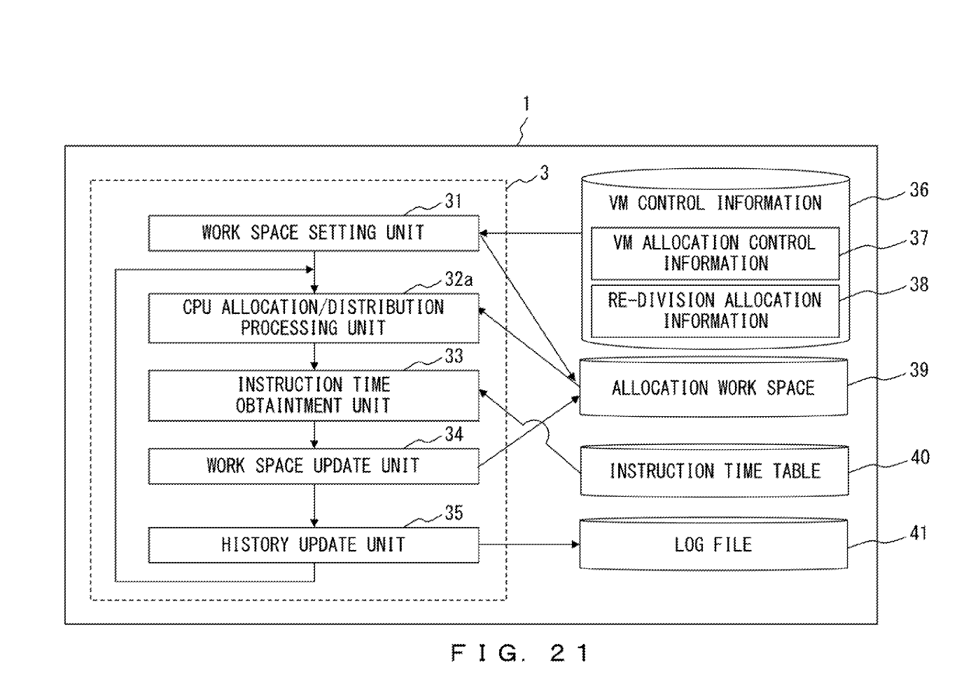

FIG. 21 illustrates an example of a functional block of the computing machine 1 in accordance with the second embodiment. In the computing machine 1 in FIG. 21, a CPU allocation/distribution processing unit 32a is provided instead of the distribution processing unit 32 in FIG. 5. In a distribution process performed on a sub-VM by sub-VM basis, the CPU allocation/distribution processing unit 32a allocates the distribution process to be performed on a sub-VM by sub-VM basis to CPUs other than the one performing this process. The CPUs to which the distribution process to be performed on a sub-VM by sub-VM basis has been allocated execute the distribution process performed on a sub-VM by sub-VM basis.

The instruction time obtainment unit 33, the work space update unit 34, and the history update unit 35 are similar to those described in the first embodiment except for the fact that a CPU executed in a distribution process executed on a sub-VM by sub-VM basis is a CPU to which a process is allocated by the CPU allocation/distribution processing unit 32a.

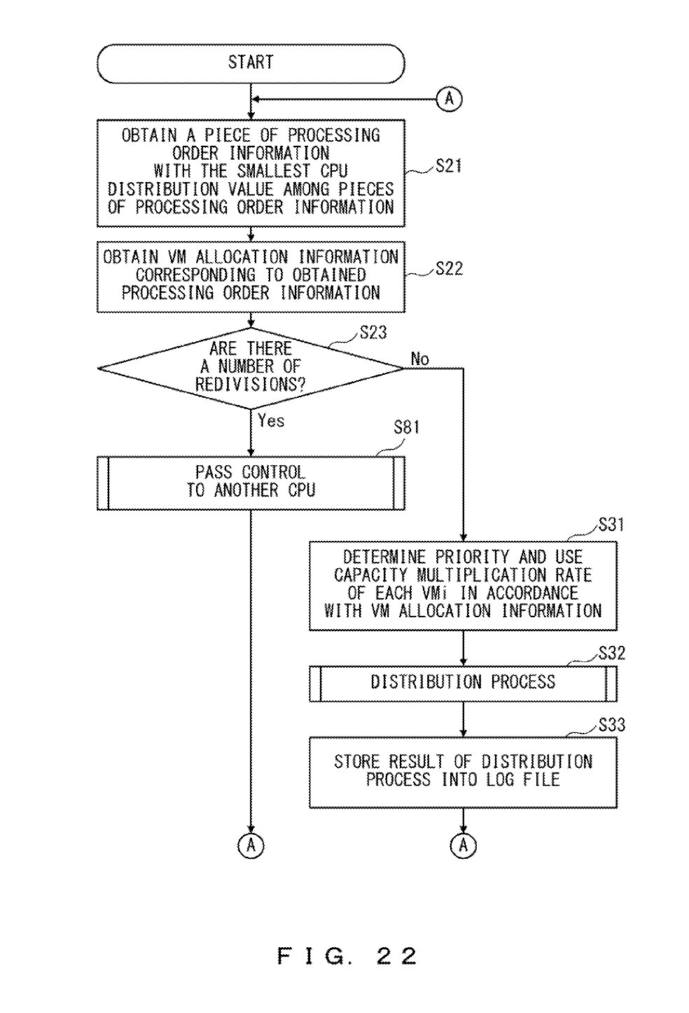

FIG. 22 illustrates a flowchart which indicates a procedure for distributing processes, the procedure being executed by the control unit 12a in accordance with the second embodiment. At startup of the computing machine 1, the first CPU 12a-1 of the control unit 12a reads a program of VMM 3 from a storage apparatus and executes it.

As a result, in accordance with the program of the VMM 3, the first CPU 12a-1 functions as the work space setting unit 31, the distribution processing unit 32, the instruction time obtainment unit 33, the work space update unit 34, and the history update unit 35 and performs the following processes.

The first CPU 12a-1 executes the flow in FIG. 22 using VM control information (VM allocation control information 37 and re-division allocation information 38) and processing order information 80 expanded within the allocation work space 39 described with reference to FIGS. 10A, 10B and 10C.

First, the first CPU 12a-1 obtains a piece of processing order information having the smallest CPU distribution value among pieces of processing order information 80 expanded within the allocation work space 39 (S21). In the present embodiment, the VM with the smallest CPU distribution value is initially processed in S21; however, the order is not limited to this. As an example, the first CPU 12a-1 may initially process the VM with the largest CPU distribution value.

Next, the first CPU 12a-1 refers to the “VMi name” of the processing order information obtained in S21 and obtains, from the VM allocation control information 37, VM allocation information i associated by the “VMi name” (S22).

The first CPU 12a-1 determines whether a value has been set to “the number of re-divisions” of the VM allocation information i obtained in S22 or whether “the number of re-divisions” which has been set is as large as or larger than two (S23). When a value has not been set to “the number of re-divisions” of the VM allocation information i obtained in S22 or when “the number of re-divisions” which has been set is smaller than two (“No” in S23), the first CPU 12a-1 performs the process of S31. The process of S31 and the following processes are similar to those in FIG. 11, and hence their descriptions will be omitted.

When a value is set to “the number of re-divisions” of VM allocation information i obtained in S22 or when “the number of re-divisions” which has been set is as large as or larger than two (“Yes” in S23), the first CPU 12a-1 performs the following processes. That is, in accordance with the control of the OS, the first CPU 12a-1 selects any of the CPUs of the control unit 12a not including the first CPU 12a-1 (hereinafter referred to as a second CPU 12a-2). As a result, the processing control is passed to the second CPU 12a-2 (S81).

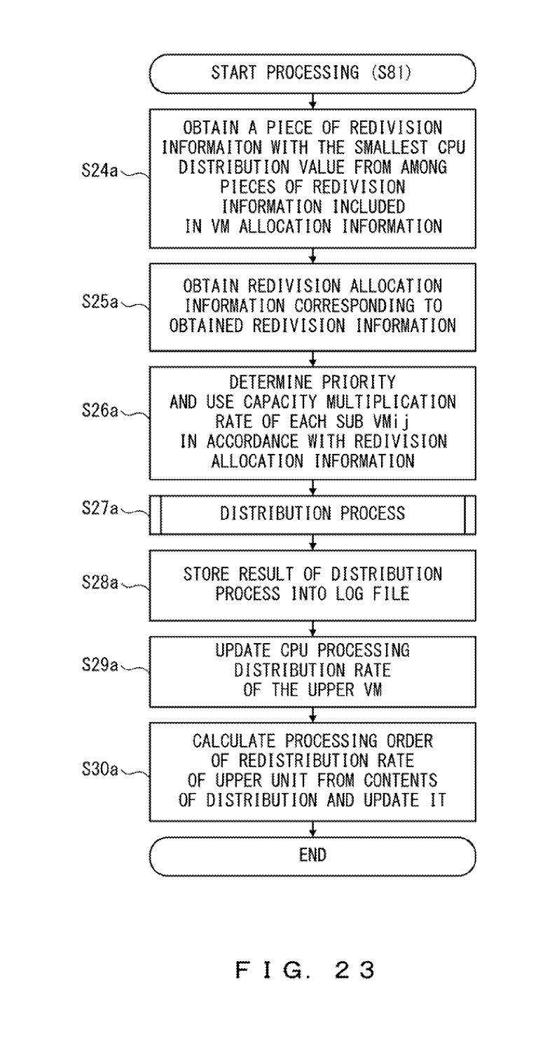

FIG. 23 illustrates an example of details of the process of S81. The second CPU 12a-2 executes S24a to S30a. The processes of S24a to S30a are similar to those of S24 to S30 in FIG. 11. When the process of S30a is finished, the processing control returns to the first CPU 12a-1.

As a result, it is possible to prevent processes from concentrating on the first CPU 12a-1 in addition to achieving the effect of the first embodiment, and hence processing loads on the first CPU 12a-1 may be reduced. In addition, since a plurality of CPUs can deal with the process to be performed on a sub-VM by sub-VM basis, the processing speed may be enhanced.

In accordance with the virtual-machine control program, resources of a plurality of virtual machines of each user may be effectively used within the scope of the processing capacities distributed to the users.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computing machine comprising:
a first setting unit to set an upper limit of an available processing capacity for each user;
a second setting unit to set a plurality of virtual machines for each of the users; and
a distribution processing unit to distribute the processing capacity to the plurality of virtual machines for each of the users within the upper limit of the processing capacity set for each of the users.

2. The computing machine according to claim 1, wherein
the first setting unit sets at least one virtual machine as an upper virtual machine for each of the users within the upper limit of the processing capacity set for each of the users, and
the second setting unit sets a plurality of virtual machines as lower virtual machines controlled by the upper virtual machine which has been set.

3. The computing machine according to claim 2, wherein
the second setting unit sets an upper limit of the processing capacity for each virtual machine controlled by the upper virtual machine within a scope of the processing capacity distributed to the upper virtual machine, and
when any of the lower virtual machines controlled by the upper virtual machine has applied to it a limitation cancellation setting for cancelling the upper limit of the processing capacity distributed to the lower virtual machines, then the distribution processing unit distributes, to the lower virtual machine which has applied to it the limitation cancellation setting, the processing capacity which has been distributed to an unused lower virtual machine for which the upper limit of the processing capacity has been set under control of the same upper virtual machine.

4. The computing machine according to claim 3, wherein
the second setting unit sets a lower limit of the processing capacity for any of the lower virtual machines, and
the distribution processing unit ensures the processing capacity for which a lower limit has been set and which is to be distributed to the lower virtual machines and distributes, to a lower virtual machine which has applied to it the limitation cancellation setting, the processing capacity exceeding the ensured processing capacity from among the processing capacity which has been distributed to an unused lower virtual machine for which the upper limit of the processing capacity has been set under control of the same upper virtual machine.

5. The computing machine according to claim 2, wherein
the distribution processing unit comprises:
a first control unit to distribute the processing capacity to the plurality of upper virtual machines; and
a second control unit to distribute the processing capacity to a plurality of virtual machines controlled by the upper virtual machines.

6. The computing machine according to claim 2, wherein
the distribution processing unit allocates a processing execution time to the upper virtual machine or lower virtual machine in an order which depends on the processing capacity distributed to the upper virtual machine or the lower virtual machine.

7. The computing machine according to claim 6, wherein
the distribution processing unit consecutively allocates the processing execution time to the upper virtual machine or the lower virtual machine to which the processing execution time has been allocated.

8. A computer-readable storage medium which stores a virtual machine control program for cause a computer to control a plurality of virtual machines, wherein the program causes the computer to execute the processes of:
setting an upper limit of an available processing capacity for each user;
setting a plurality of virtual machines for each of the users; and
distributing the processing capacity to the plurality of virtual machines for each of the users within the upper limit of the processing capacity set for each of the users.

9. The computer-readable storage medium according to claim 8, wherein
in setting the upper limit of the available processing capacity for each user, at least one virtual machine is set as an upper virtual machine for each of the users within the upper limit of the processing capacity set for each of the users, and
in setting the plurality of virtual machines for each of the users, a plurality of virtual machines are set as lower virtual machines controlled by the upper virtual machine which has been set.

10. The computer-readable storage medium according to claim 9, wherein
in setting the plurality of virtual machines for each of the users, an upper limit of the processing capacity is set for each virtual machine controlled by the upper virtual machine within a scope of the processing capacity distributed to the upper virtual machine, and
in distributing the processing capacity to the plurality of virtual machines,
when any of the lower virtual machines controlled by the upper virtual machine has applied to it a limitation cancellation setting for cancelling the upper limit of the processing capacity distributed to the lower virtual machines, then the processing capacity which has been distributed to an unused lower virtual machine for which the upper limit of the processing capacity has been set under control of the same upper virtual machine is distributed to the lower virtual machine which has applied to it the limitation cancellation setting.

11. The computer-readable storage medium according to claim 10, wherein
in setting a plurality of virtual machines for each of the users, a lower limit of the processing capacity is set for any of the lower virtual machines, and
in distributing the processing capacity to the plurality of virtual machines,
the processing capacity for which a lower limit has been set and which is to be distributed to the lower virtual machines is ensured, and the processing capacity exceeding the ensured processing capacity from among the processing capacity which has been distributed to an unused lower virtual machine for which the upper limit of the processing capacity has been set under control of the same upper virtual machine is distributed to a lower virtual machine which has applied to it the limitation cancellation setting.

12. The computer-readable storage medium according to claim 9, wherein
in distributing the processing capacity to the plurality of virtual machines,
a first control unit is caused to perform a process of distributing the processing capacity to the plurality of upper virtual machines, and
a second control unit is caused to distribute the processing capacity to a plurality of virtual machines controlled by the upper virtual machines.

13. The computer-readable storage medium according to claim 9, wherein
in distributing the processing capacity to the plurality of virtual machines, a processing execution time is allocated to the upper virtual machine or the lower virtual machine in an order which depends on the processing capacity distributed to the upper virtual machine or the lower virtual machine.

14. The computer-readable storage medium according to claim 13, wherein
the processing execution time is consecutively allocated to the upper virtual machine or the lower virtual machine to which the processing execution time has been allocated.

15. A virtual machine controlling method executed by a computer to control a plurality of virtual machines, wherein
the computer executes the processes of
setting an upper limit of an available processing capacity for each user,
setting a plurality of virtual machines for each of the users, and
distributing the processing capacity to the plurality of virtual machines for each of the users within the upper limit of the processing capacity set for each of the users.

16. The virtual machine controlling method according to claim 15, wherein
in setting the upper limit of the available processing capacity for each user, the computer sets at least one virtual machine as an upper virtual machine for each of the users within the upper limit of the processing capacity set for each of the users, and
in setting the plurality of virtual machines for each of the users, the computer sets a plurality of virtual machines as lower virtual machines controlled by the upper virtual machine which has been set.

17. The virtual machine controlling method according to claim 16, wherein
insetting the plurality of virtual machines for each of the users, the computer sets an upper limit of the processing capacity for each virtual machine controlled by the upper virtual machine within a scope of the processing capacity distributed to the upper virtual machine, and
in distributing the processing capacity to the plurality of virtual machines,
when any of the lower virtual machines controlled by the upper virtual machine has applied to it a limitation cancellation setting for cancelling the upper limit of the processing capacity distributed to the lower virtual machines, then the computer distributes, to the lower virtual machine which has applied to it the limitation cancellation setting, the processing capacity which has been distributed to an unused lower virtual machine for which the upper limit of the processing capacity has been set under control of the same upper virtual machine.

18. The virtual machine controlling method according to claim 17, wherein
in setting a plurality of virtual machines for each of the users, the computer sets a lower limit of the processing capacity for any of the lower virtual machines, and
in distributing the processing capacity to the plurality of virtual machines,
the computer ensures the processing capacity for which a lower limit has been set and which is to be distributed to the lower virtual machines, and,
the computer distributes, to a lower virtual machine which has applied to it the limitation cancellation setting, the processing capacity exceeding the ensured processing capacity from among the processing capacity distributed to an unused lower virtual machine for which the upper limit of the processing capacity has been set under control of the same upper virtual machine.

19. The virtual machine controlling method according to claim 16, wherein
in distributing the processing capacity to the plurality of virtual machines,
the computer causes a first control unit to perform a process of distributing the processing capacity to the plurality of upper virtual machines, and
the computer causes a second control unit to distribute the processing capacity to a plurality of virtual machines controlled by the upper virtual machines.

20. The virtual machine controlling method according to claim 16, wherein
in distributing the processing capacity to the plurality of virtual machines, the computer allocates a processing execution time to the upper virtual machine or the lower virtual machine in an order which depends on the processing capacity distributed to the upper virtual machine or the lower virtual machine.
